(19) United States
(12) Patent Application Publication
(10) Pub. No.: US 2002/0138389 A1
(43) Pub. Date: Sep. 26, 2002

(54) Browser interface and network based financial service system

(76) Inventors: Brian Joseph Martone, Hoboken, NJ (US); Richard F. Murphy, New Hyde Park, NY (US); Michael Francis Murphy, River Edge, NJ (US)

Correspondence Address: Leslie Gladstone Restaino, Esq., Brown Raysman Millstein Felder & Steiner LLP, 4th Floor, 55 Madison Avenue, Morristown, NJ, 07960, US

(21) Appl. No.: 10/143,477

(22) Filed: May 10, 2002

Related U.S. Application Data
(63) Continuation-in-part of application No. 09/712,358, filed on Nov. 14, 2000.
(60) Provisional application No. 60/182,364, filed on Feb. 14, 2000.

(51) Int. Cl. G06F 17/60

(52) U.S. Cl. 705/36

(57) ABSTRACT

A browser interface for providing financial services is provided. The interface comprise a toolbar; a task menu wherein each task is associated with a number of financial applications; an object menu associated with each task which provides a link to each financial application; and an action menu for presenting one or more actions specific to a user-selected financial application. The task menu is always present on the browser interface and the object and action menus vary depending upon the options selected. The financial applications include market monitoring functions, portfolio reviews, model balancing, and automated trading.

### CROSS REFERENCE TO RELATED APPLICATIONS

This application is a continuation-in-part of U.S. patent application Ser. No. 09/712,358, filed Nov. 14, 2000, entitled Browser Interface and Network Based Financial Service System, which in turn claims the benefit of U.S. Provisional Application No. 60/182,364, filed Feb. 14, 2000, entitled System For Providing Financial Services.

### BACKGROUND OF THE INVENTION

1. Field of the Invention:

The present invention relates to financial consulting; and more particularly, to a browser interface and client-server system for providing financial services.

2. Description of the Prior Art:

Many people turn to financial advisors for specialized investment advice. Typically, financial advisors utilize a number of disparate tools to formulate a discrete financial plan. These include financial planning calculators, review of historical market trends and yield calculations, and the like. In some instances, certain of these tools may be automated; others require manual use.

The financial industry has identified the need to automate financial services. For example, U.S. Pat. No. 5,132,899 discloses a computer data gathering and processing methodology that facilitates access to various data including investment performance, Securities Exchange Commission reports, and stock financial characteristics to produce a list of stocks for purchase for investment and operating accounts. U.S. Pat. Nos. 5,710,889 and 5,890,140 disclose a device and system for electronically integrating a plurality of financial services from different geographical locations and in different time zones.

There have likewise been developed a number of computerized financial advisory systems. U.S. Pat. No. 5,918,217 discloses a user interface which allows a user to interactively explore how changes in one or more input decisions, such as risk tolerance, savings level, and retirement age affect one or more output values such as the probability of achieving specified financial goals. Some of these tools are available over the Internet. At <<http://www.armchairmillionaire.com/fivesteps/intro.html>> there is provided an interactive savings tool, which explores how to build a million-dollar portfolio, based on total dollar inputs.

In some instances, there have been attempts to integrate different automated financial tools. U.S. Pat. No. 5,245,535 discloses a system for demonstrating and displaying different financial concepts, which includes a central processing unit for processing financial information from numerical data and a display means for displaying the financial information in graphic and textual form. U.S. Pat. No. 5,214,579 discloses a data processing system that manages, monitors and reports the growth of a participant's investment base with respect to progress in achieving a predetermined target amount.

None of the patents or systems described above disclose a secure system, having a myriad of integrated financial application and tools which can be easily navigated by financial advisors. Furthermore, with the proliferation of investors in recent times and the ever-increasing use of the Internet to disseminate financial information as well as a medium for investors to open up and manage accounts, financial advisors may have a difficult time marshalling all of the necessary data required to effectively manage and/or advise their clients.

### SUMMARY OF THE INVENTION

According to one aspect of the invention, a browser interface is provided for an integrated financial services system. The interface includes a browser toolbar and a task menu providing a number of user-selectable tasks that correspond to various activities performed by financial advisers on a daily basis. Each task is associated with a group of financial applications logically associated with the task. An object menu is associated with each user-selected task so as to provide the user with a user-selectable link for initiating each financial application associated with the user-selected task. Once initiated, each financial application includes an action menu for presenting one or more actions specific to the user-selected financial application. The interface also includes at least one view window for presenting information from at least one of the financial applications.

In the preferred embodiment, each task selection is associated with an object menu that is viewable when the task is selected by the user. The task menu preferably presents one or more of the following task selections: a default task; client information; investor consulting services; products and investments; tools; and management. The default task is associated with one more of the following object menu selections: research; applications; market data; client inquiry; Infonet (an information resource web site); and dynamic market data. The investor consulting services task is associated with one more of the following object menu selections: online portfolio review; financial planning; and trading.

According to another aspect of the invention, a method of preparing and tracking client presentations is provided. According to this method a presentation file having a plurality of slides is uploaded to a database. The presentation file is then split into individual slides, which are separately stored in the database. A user interface is provided for enabling a user to select any of the individual slides for a new client presentation. The identity of the client for the new client presentation is stored in the database as well as data indicating the individual slides which compose the new client presentation. In this manner, presentations can be created from a central, management-approved, repository, and management can track what information has been presented to clients or prospective clients.

According to yet another aspect of the invention, a method of balancing a financial portfolio comprising multiple accounts is provided. The method includes: selecting multiple financial accounts from a database of client financial accounts; selecting a financial model; comparing the holdings in the selected multiple financial accounts, in aggregate, against the financial model; and initiating buy and sell orders, as required, in order to substantially equalize the selected multiple financial accounts, in aggregate, with the financial model. The selected accounts are preferably balanced with the financial model to within a rounding factor. In this manner, financial advisors can more effectively manage householded accounts.

According to still another aspect of the invention, a method of analyzing a financial portfolio is provided. The method includes: selecting a plurality of financial accounts from a database of financial accounts; selecting a comparative index evaluator against which to evaluate the selected plurality of accounts; and visually comparing the asset allocation of the selected plurality of accounts against the asset allocation of the comparative index evaluator. The method enables financial advisors to more effectively manage householded accounts.

### BRIEF DESCRIPTION OF THE DRAWINGS

The invention will be more fully understood and further advantages will become apparent when reference is made to the following detailed to description of the preferred embodiments of the invention and the accompanying drawings, in which:

FIG. 1 is a block diagram of a network based financial service system;

FIG. 2 is a schematic representation of a computer/workstation for accessing the system of FIG. 1 via the Internet;

FIG. 3 is a block diagram of the software hierarchy of a host server of the system;

FIG. 4 is a block diagram of an authentication system;

FIGS. 5-7 are flow diagrams of operation of the authentication system;

FIGS. 8A-B are video screen displays illustrating authentication login screens, respectively;

FIG. 9 is a screen display illustrating a browser interface, and in particular, an order entry application;

FIG. 10 is a screen display of a market data function;

FIG. 11 is a screen display of a financial research information web site;

FIG. 12 is a screen display of a client inquiry application;

FIG. 13 is a screen display of an intranet web site;

FIG. 14 is a screen display of a dynamic market data function;

FIGS. 15-23 are screen displays of various tools associated with an online portfolio review application;

FIG. 24 is a screen display of an Insightone™ application;

FIG. 25 is a screen display of a financial planning application;

FIGS. 26-35 are screen displays of various tools associated with an investment consulting services trading application;

FIG. 36 is a screen display of a client reporting function;

FIG. 37 is a screen display of a branch report function; and

FIG. 38 is a screen display of a portfolio management report function.

### DETAILED DESCRIPTION OF THE PREFERRED EMBODIMENTS

The detailed description is organized as follows:

I. System and Components

A. Software Overview

B. Browser Interface Overview

C. Authentication System Overview

D. Computer or Workstation

E. Host Server(s)

II. Software

III. Authentication System

IV. Browser Interface & Functional Description

A. Main Menu (Home)

1. Applications

2. Market Data

3. Research

4. Client inquiry

5. InfoNet

6. Dynamic Market Data

B. Investment Consulting Services (ICS)

1. Online Portfolio Review

2. InsightOne Web site

3. ICS Financial Planning

4. ICS Trading

C. Client Info

1. View

2. Branch Reports

3. Portfolio Management Reports

I. System and Components:

The present invention provides specially integrated tools for processing and viewing market data and research, providing financial planning, conducting financial transactions and monitoring investor activities. The advanced technology platform afforded by the present invention provides a browser interface, accessible over the Internet, to offer timely, proactive financial advice based on real-time financial data and a myriad of finance related applications.

A. Software Overview:

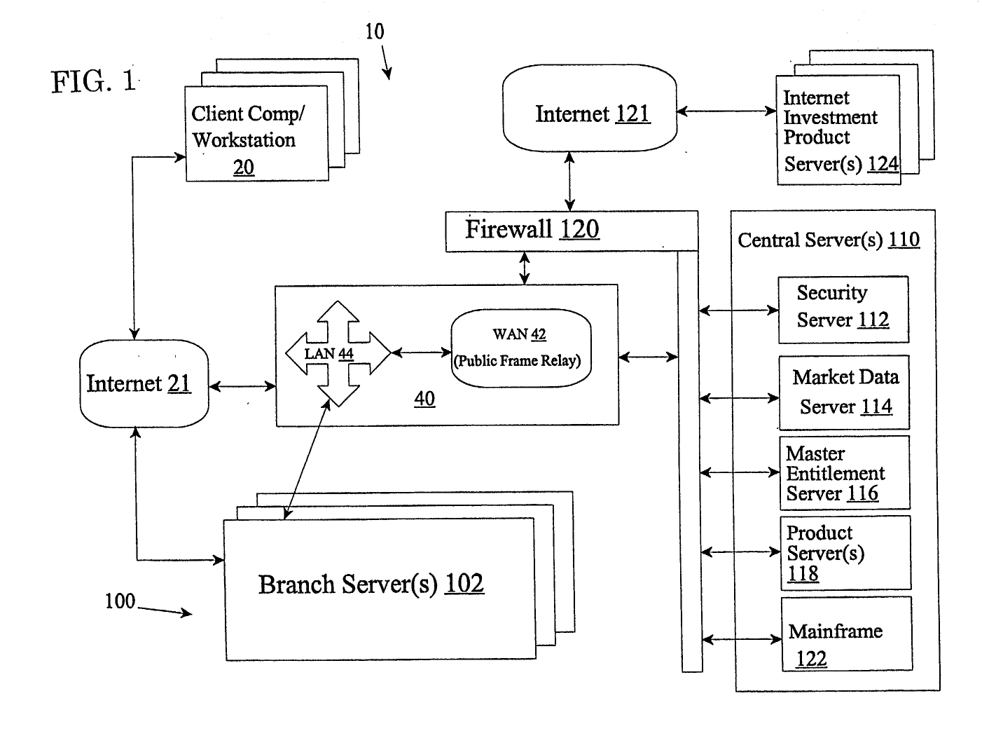

Referring to FIG. 1, there is shown a financial service system 10 which incorporates a number of different software applications, functions and information content Web sites/pages, which, for purposes of this disclosure, are generically referred to as “objects” or “system features” (“features” for short). For further purposes of this disclosure, an “application” is software that provides a variety of functions and calculations, and a “function” is a discrete, more granular procedure such as selecting and reporting data.

In a preferred embodiment, system 10 includes a set of objects that can be used to process and view real-time market data and assist financial planning. Additional, preferred objects may be used to perform market research and monitor and assist in investor-mediated financial activities. The stability, functionality, easy usability and flexibility of the integrated system of the invention provide timely, proactive advice and counsel, thereby furthering investor goals.

The objects may reside in part on any component server or database of host server 100, shown in FIG. 1, for access by a client computer or workstation 20 via the Internet.

B. Browser Interface Overview:

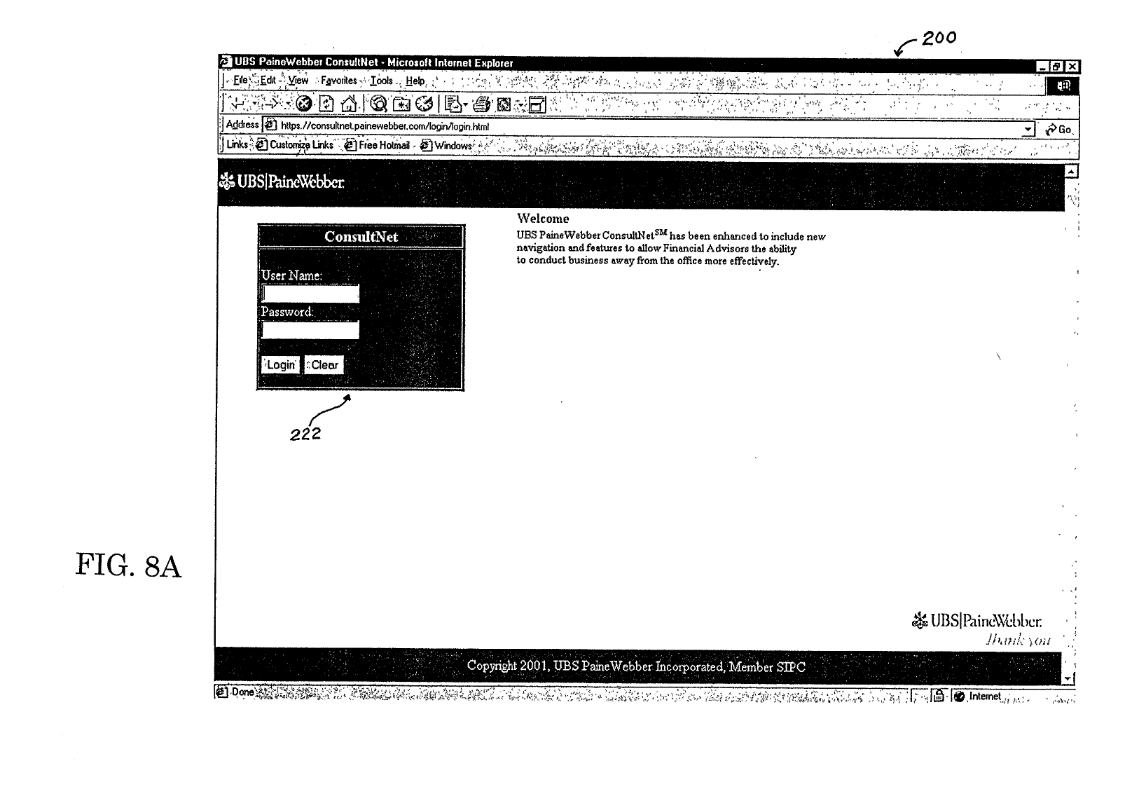

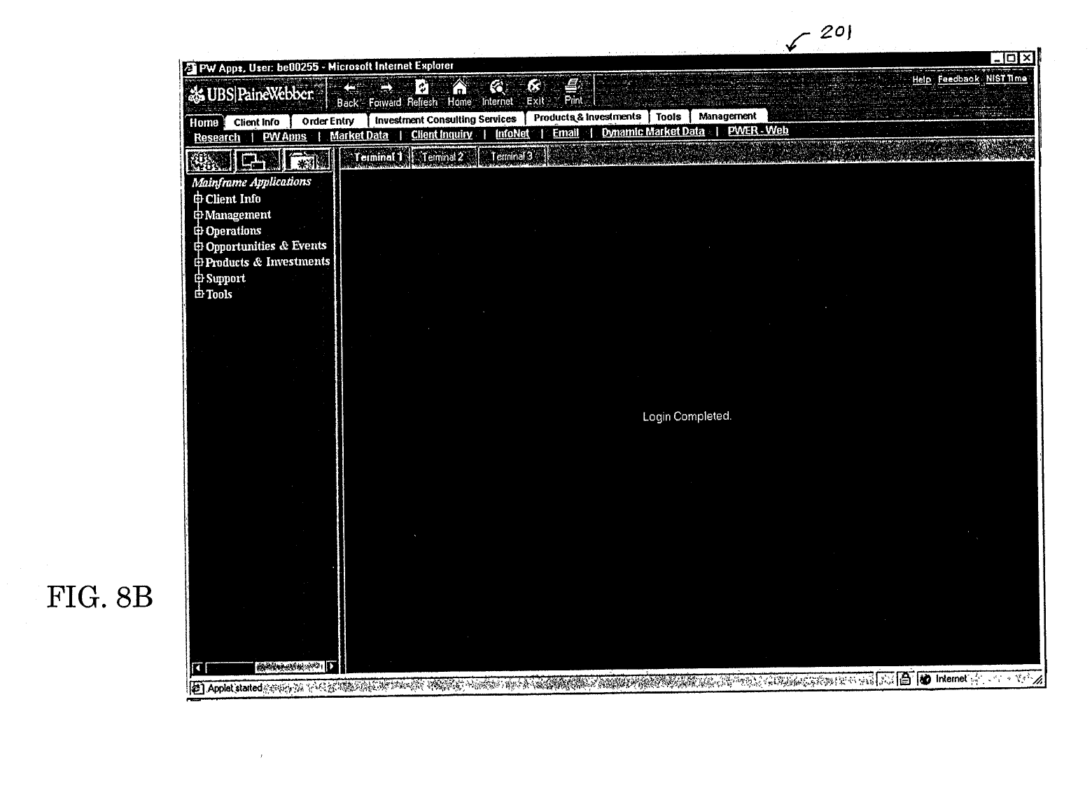

In a preferred embodiment, objects are integrated with a browser interface 200 (or controlled shell), shown in FIGS. 8A-38, in a manner that enables a user to view one or more graphical displays from a given object.

Accordingly, system 10 provides a multitasking environment in which more than one objective application, function or Web site and/or page can be simultaneously run and/or viewed by the user. In this environment, an interface may have two or more windows, each representing a different object governed by its own protocols distinct to that object. The user can move between different windows, without having to constantly enter and exit each object of interest. Depending on the particular needs or questions of the user, appropriate objects can be accessed and utilized to generate financial information. For example, the user could request research on particular market sectors and specific equity positions within that sector. In a preferred embodiment, browser interface 200 is accessible from a workstation 20 via the Internet to access a plurality of financial applications and a plurality of market data functions. Real-time market data can be utilized in conjunction with financial applications in order to provide comprehensive financial assistance. In another instance, the user (i.e., financial adviser) may desire to monitor the activities of his or her client through an investor monitoring system. Here, the user could intercede in an order entered by the client or, alternatively, contact the client to discuss the ramifications of a particular order. Preferably, a scratchpad interface for moving information between the objects may also be provided.

C. Authentication System Overview:

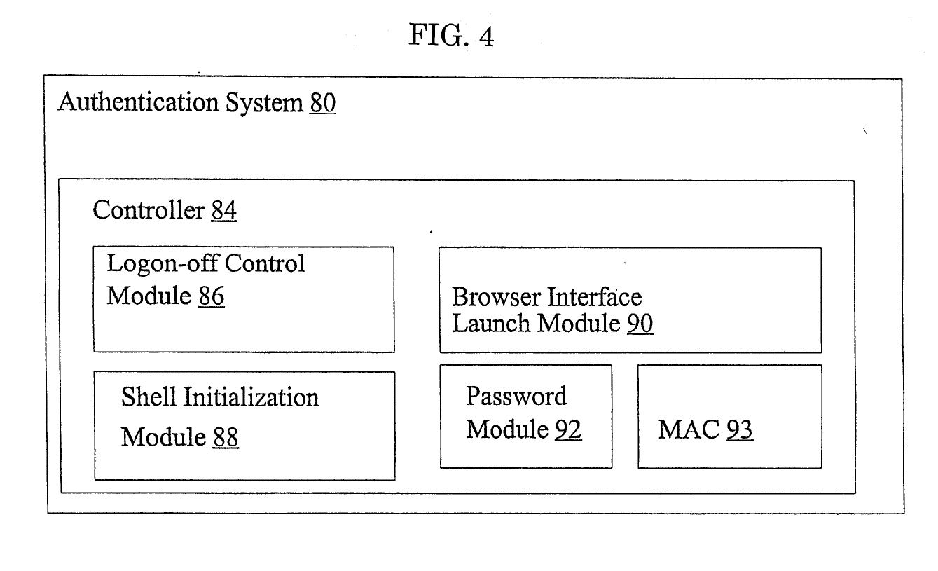

The invention also may include an authentication system 80, shown in FIG. 4, described in detail further below. Generally stated, once communications to a host server have been established, a user logs onto system 10 and accesses authentication system 80, where the user enters a password and preferably, other authentication information such as a universal user name. This information is transmitted to a security system resident in host server 100 where a user is authenticated. This provides for confirmation of a user's identity. Concomitantly, user access is denied where authentication fails. The security functionality described herein also represents a single point of security control for adding or removing a user from the system 10. Preferably, the security system is resident in more than one component of host server 100 in order to provide load balancing and disaster recovery.

In addition, authentication system 80 also provides access to a user entitlement level containing a list of objects according to user entitlement. That is to say, different users are accorded different entitlement levels and as such, access to specific objects resident in system 10. For example, a sales person would not receive alerts regarding investor-mediated transactions and therefore would not be allowed access to those applications. Most preferably, a separate user entitlement level associates a user with specific market data.

In a preferred embodiment, the authentication system also contains a move/add/change (MAC) function 93 that updates the security 25 function with new or changed user information. Preferably, the MAC function 93 updates the security function with new or revised user names, social security functions, unique advisor identification number (where appropriate), identification for market data entitlements, and satellite branch identifiers (where appropriate), as well as an e-mail alias and title. The MAC function 93 is a single entry point to fully add or remove a user from all required security or distributed systems that support platform functionality.

In addition, authentication system 80 accesses a user customized preference profile resident on the host server 100. The user preference profile allows a user to customize his or her browser interface and object settings, such as market data function preferences.

By providing the entitlement levels and preference profiles, the present invention allows a user to access system 10 entitlements via the Internet. In addition, the user retains all of his or her preferences set during a user's previous usage.

D. Computer or Workstation:

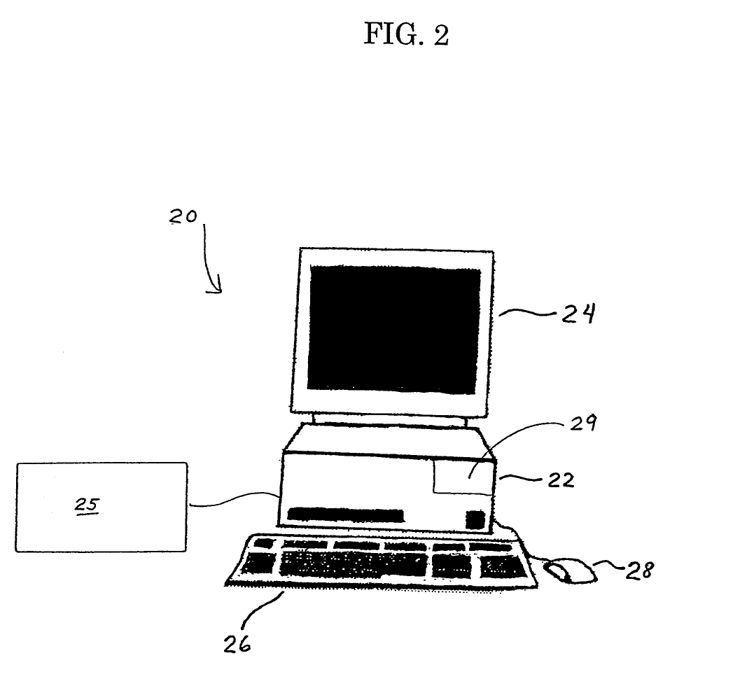

A component of the present invention is a client computer or workstation 20 including Internet 21 access. (This differs from Internet access relative to firewall 120 only.) Workstation 20 can be used to review real-time market conditions, obtain research, assist financial planning, monitor financial activities, enter orders for the execution of security transactions, and conduct numerous other financial activities. Workstation 20 is fast, simple to use, and is readily adaptable to the needs of the user. As shown in FIG. 2, workstation 20 includes a central processing unit 22, a video display screen (VDS) 24, communication system 29 for communicating between workstation 20 and at least one host server 100 via the Internet 21, and a browser interface 200 (shown in FIGS. 8A-38).

VDS 24 is connected to a color video graphic controller card of workstation 20 and provides means by which financial information is displayed on VDS 24 in graphic form. Preferably, CPU 22 is housed in a single stationary or portable unit. CPU 22 of a stationary workstation 20 may comprise an IBM desktop personal computer with 96 megabytes of RAM, a 350 megahertz INTEL Pentium II processor, a 4.5 gigabyte hard drive, and a color video graphic controller card. Preferably, VDS 24 is a 17-inch color monitor with a screen resolution of at least 800×600 pixels, such as those sold by Sony Corp. of America. As an option, a printer 25 may be connected to CPU 22.

A portable workstation may likewise be used with system 10. In one embodiment, the portable workstation comprises, for example, a laptop computer having at least a 166 megahertz INTEL Pentium processor, 64 kilobytes of RAM, and a screen resolution of at least 800×600 pixels.

As mentioned above, workstation 20 also includes Internet access. To this end, communication system 29 includes a modem having a speed of 28.8 kilobytes per second (Kbps), although a modem speed of 56 Kbps is preferred. Of course, high-speed connections such as ISDN, cable modems, or digital subscriber lines may be used. Preferably, all data transmitted over the Internet is encrypted, e.g., with 128-bit encryption or like technology. Encryption ensures that account integrity will be maintained. It should be recognized that while the present invention will be described in terms of “Internet” communication, that more specific communication networks, such as a virtual private network or secured extranet, are considered to be within this realm. In any case, connectivity is preferably provided by conventional TCP/IP sockets-based protocol.

CPU 22 also includes mechanisms for selectively controlling the display of information on VDS 24 as well as devices for entering data into the system. Preferably, workstation 20 includes a keyboard 26 and a mouse 28 for entering information and directing the graphical display on VDS 24.

All of the hardware elements described herein may be readily replaced with other existing or later-developed elements that perform similar functions. For example, many different types of CPU's may be used instead of the unit described above.

Likewise, touch screen displays, light pens, track balls, keypads, stylus-type input devices or any other input device may be used instead of or in addition to keyboard 26, mouse 28, or both.

Every workstation 20 is programmed with operating system software such as Windows NT® 4.0 from Microsoft Corp. Each workstation 20 may 25 also contain a number of software applications. For example, workstation 20 may have a suite of applications from Microsoft Office® (i.e., Outlook, Word, Excel, PowerPoint), Norton Utilities®, various proprietary software for authenticating user access to the workstation, and non-proprietary finance-related applications. Each workstation 20 is also equipped with an Internet browser such as Microsoft's Internet Explorer® 4.0 or greater, or Netscape Navigator. Alternatively, as will be discussed below, these applications may be resident on the host server and accessed as necessary via browser interface 200. The hardware and software framework described herein allows a user at any workstation 20 to access a host server 100 via the Internet, and utilize all available objects resident therein to which the user is entitled. In this way, system 10 can be used to provide superior financial assistance from remote locations.

E. Host Server(s):

In a preferred embodiment, the objects necessary to practice the present invention may reside a single server computer. However, as is evident from FIG. 1, system 10 preferably includes more than one server 10 computer, which collectively are referred to as “host server” 100. Any number of workstations 20 may connect to host server 100 via the Internet 21. System 10 is preferably implemented in such a way as to optimize on infrastructure costs. Client workstations connect to the system from the Internet using Internet Explorer 4.x or greater. All server code utilizes Netscape Enterprise Server and Server Side JavaScript (LIVEWIRE). CISCO Distributed Director (which is utilized for Load-Balancing, Fail-Over and Disaster Recovery) controls access to product server(s) 118 from referencing the Universal Resource Locator (URL). As will be discussed in greater detail later, user authentication is accomplished via authentication processes run against the master entitlement server 116. User entitlements and permissions are achieved through access to the master entitlement server 116, using profile information gathered from the authentication process. For the purpose of this disclosure, master entitlement server 116 may comprise one or more servers; for example, an authentication server for user authentication and an entitlement server for establishment of user entitlements and permissions. Other preferable tools which are maintained in host server 100 are built in JAVA and are resident at browser interface 200. These include: 1) a navigation bar feature which provides for “closed browser shell” navigation to all entitled objects; 2) a scratchpad feature which provides for object to object “stickiness” or context (e.g., carries information such as a symbol or account number from application to application without re-entry) and also allows the ability for single sign-on for multiple applications/content; and 3) a customized application built around IBM's Host On Demand (HOD) 327x emulation which provides for the establishment of a user entitlement based NAVIGATION TREE. Market data information is built using JAVA-based web pages from data accessed on market data server 114 as well as any other market data servers not shown in FIG. 1, such as those maintained as part of branch server 102, using user profile information supplied from the navigation feature. System 10 utilizes identical central server 110 components to the system described in the co-pending application entitled “System for Providing Financial Services.”

II. Software

The only software necessary to practice the present invention on workstation 20 is an Internet browser such as Microsoft's Internet Explorer and any Internet access software required, e.g., Internet service provider dial up software. Workstation 20 accesses host server 100 via Internet 21 either by accessing branch server 102, which in turn may access other components 15 of host server 100, or via centralized communication system 40. Objects are provided over Internet 21 from host server 100 to workstation 20, as described below.

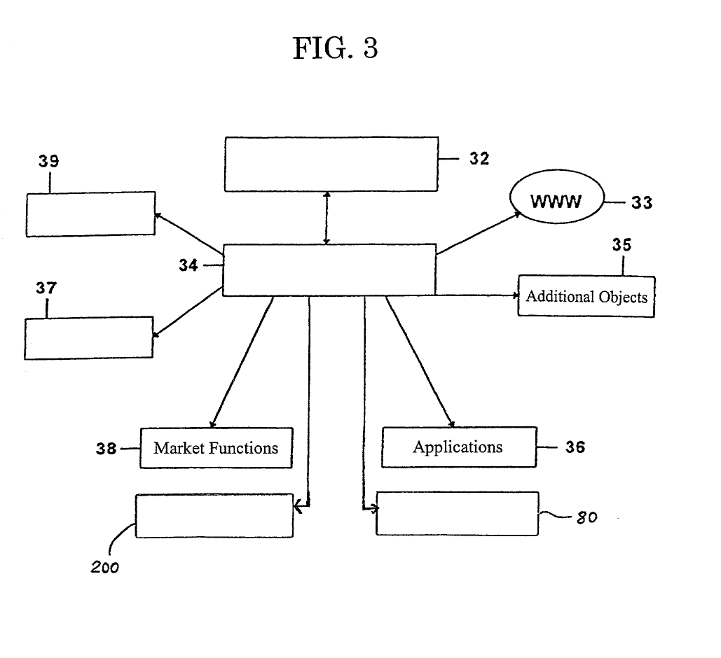

Referring to FIG. 3, a software hierarchy of host server 100 is shown. At the lowest level of the software hierarchy, operating system software 32 is provided. Preferably, operating system software 32 is a Windows NT® 4.0 operating system from Microsoft Corp. As well known by those having skill in the art, operating system software 32 causes the hardware components to operate in combination with one another by accepting input data, processing input data, and producing output data.

Conventional communications software 34 runs on top of operating system 32. This software permits user interaction with a keyboard, mouse or similar input device of host server 100 to control the operation of the software and other applications resident on the host server 100. It also serves as a means for transmitting information between the components of host server 100. As indicated in FIG. 3, communications software 34 is also linked to the Internet access 33, which accesses Internet 121 through firewall 120. Due to firewall 120, Internet access 33 of host server 100 allows a user to more securely conduct search via system 10 for investment information, background information, breaking news that affects investments and the like. Internet access 33 also allows a user to communicate with other users through system 10 and with clients via e-mail packages such as provided by Microsoft Outlook. This provides means to access the Internet, send e-mail, search at least one browser-based information system, etc.

Browser interface 200 and authentication system 80 are applications running on top of operating system software 32. The function and details of these applications are discussed below.

As shown in FIG. 3, communications software 34 is also preferably 10 linked to various objects that may be categorized, for convenience of description only, as a plurality of market monitoring objects 38, a plurality of functional application objects 36, and a plurality of additional objects 35. These objects will be discussed in more detail relative to browser interface 200 below.

In accordance with the present invention, the system 20 can incorporate an unrestricted number of different applications, functions and Web sites/pages. Furthermore, system 10 may include any other software 39 (FIG. 3) necessary for operation. It should be recognized that while objects are described as being “on” system 10, they be either physically located on a server or database of system 10 or may be accessed (e.g., via Internet 121 through a firewall 120) from third party service providers, e.g., Internet investment product server(s) 124.

III. Authentication System

Referring to FIGS. 4-7, an authentication system 80 of the invention is shown in greater detail. Authentication system 80 allows a user to access objects by user entitlement and access a user preference profile for that user regardless of where a workstation 20 is physically located.

Users are provided with an object suite based on a pre-determined user entitlement level. A user's entitlement level may be determined by their functional position, e.g., financial advisor, client service associate, operations manager, branch office manager, and division manager. Objects can be added or deleted to a user entitlement level as necessary. All security updates, new user, objects, adds or changes, may require secondary approval, before they are processed. It should be recognized that while the description discusses a single user entitlement level, more than one entitlement level may exist for a user, e.g., one for market data functions and another for applications.

Authentication system 80 uses the user's entitlement level to build browser interface 200 for a user. A user entitlement level is stored in an entitlement database(s) within system 10 and may include a number of identifications or passwords for the user, e.g., universal user name (UUNAME) including, for example, parent branch wire code (2 digit unique branch designation) and a Quotron® user identification (QUID). A customized user preference profile is also stored in a distributed/shared file space (DFS) which is preferably maintained within master entitlement server 116 of system 10 and contains customized settings of a user, e.g., user network registry settings for preferencing directories and files, taskbar settings, etc. A user's preference profile will be used to build browser interface 200 and provide the user with preferences that he or she has previously set.

Authentication system 80 also preferably includes a move/add/change (MAC) function 93 (FIG. 4), which provides a single point of control for all updates to user preference profiles, which in turn perform synchronous updates to all required security platforms, directories, entitlement and permission database, market data entitlements (e.g., QUID), all e-mail account information for simple mail transfer protocol (SMTP) or Microsoft Exchange based e-mail services, and all printer account information. MAC function 93 provides for distributed administration of client accounts. For example, each branch preferably has a designated MAC staff member who, via MAC function 93, has the permission to update user entitlements for those users that access system 10 from Internet through their respective branch server 102. This distributed updating is a significant advantage to the overall operation of the platform because a local administrator can administer local staff. If desired, changes may require secondary approval, for instance, by a branch manager, thereby maintaining tight security control of this distributed function.

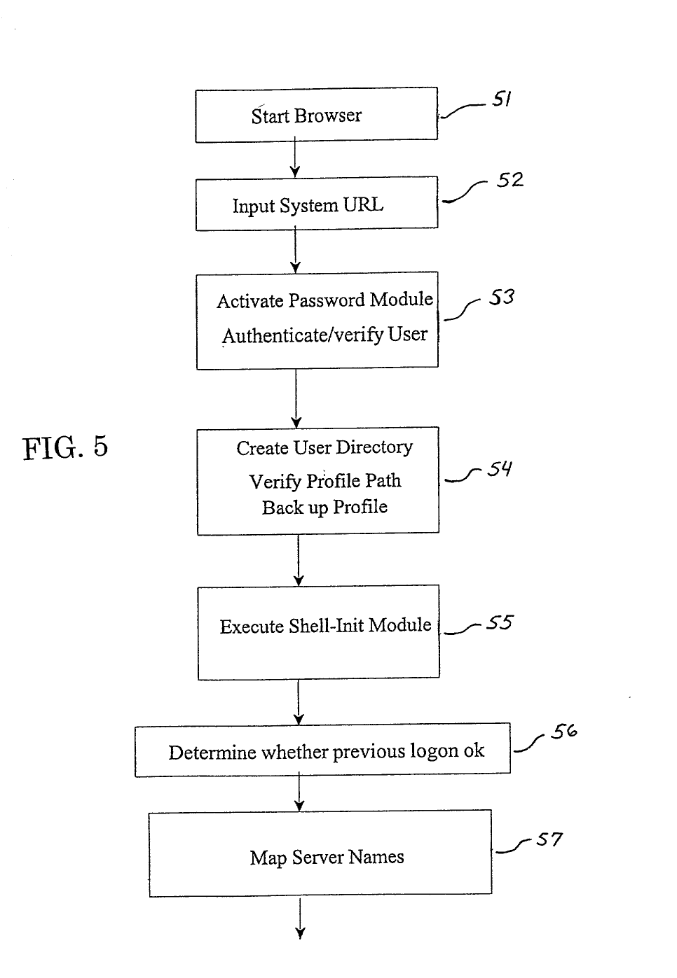

As shown in FIG. 4, authentication system 80 includes a controller 84, a logon-off control module 86, a shell initialization module 88, a browser interface launch module 90, a password module 92 and MAC function 93. Operation of authentication system 80 will be described relative to FIGS. 5-7. It is also noted that authentication system 80 will be described relative to a host server 100 having multiple components. While authentication system 80 is preferably used in a distributed server system, it should be recognized that the servers described might be condensed into a single server.

Referring to FIG. 5, in a first step S1, a user starts a workstation 20 and starts an Internet browser thereon, which accesses the Internet 21 in a known fashion. In step S2, a user inputs a uniform resource locator (URL) into the browser on their workstation 20 that will access an appropriate server of system 10. When the system 10 is accessed, controller 84 activates logon-off control module 86, which oversees the logging in process.

As will become evident, controller 84 (sometimes through modules 86, 88, 90, 92) governs a number of activities including retrieving a user's preference profile, populating' browser interface 200, finding a user's entitlement level, retrieving numerous user identifications (e.g., parent branch wirecode, market data server ID, outside Internet investment product server ID and security ID for use by shell initialization module 88), creating a local user directory based on a user's preference profile, storing user password(s) in a library for objects to retrieve, setting an access control list on a logging in user's directory to provide full control, verifying and backing up user preference profiles, removing local preference profiles (excepting defaults, administrative and guest settings), and notifying a user of password expiration.

Next, at step S3, controller 84 authenticates a user logging on by activating password module 92. Password module 92 may access a special security server 112 (FIG. 1) of central server(s) 110 to authenticate a user. Upon initialization of security server 112, a user will be presented with a dialog for input of a user name and password (shown in FIG. 8A). Controller 84 may also indicate that a password change is required, i.e., it is about to expire based on information from security server 112. At this time, the MAC function 93 notifies the user that a password-reset operation has been performed and the password must be changed. The password may be changed in any conventional way of inputting a new password with a confirmation.

At step S4, controller 84 creates a local user directory, verifies that a user preference profile path exists and backs up the user preference profile. A user preference profile may exist on a branch server 102 or another server within system 10. A user preference profile includes a number of directories and files of the user, called a registry, that are used by system 10 to access a 10 user's information. If controller 84 cannot verify a path, authentication system 80 uses a default profile. If a registry fails to load for a user, controller 84 may attempt to use a user's last known profile, which may be accessible from a back up of the profile. Creating a local user directory on workstation 20 includes mapping the directories of workstation 20 to the registry of directories and files for a user.

At step S5, after a user is authenticated, logon-off control module 86 executes shell-initialization module 88 (hereinafter “shell-init module”).

At step S6, shell-init module 88 determines whether a previous logon did not proceed normally. If this is the case, shell-init module 88 undoes the changes made during last logon, i.e., it remembers user preference profile changes made during the previous logon.

At step S7, shell-init module 88 maps server names for user information to server IP address and port number. Since the user is accessing system 10 via the Internet, the system recognizes the user as being at a remote site.

For authentication purposes, shell-init module 88 is directed to a cluster of central authentication servers. In particular, user entitlement level and user preference profiles are attained from the user's branch server 102 or a master entitlement server 116 of central server(s) 110. Preferably, shell-init module 88 will point to the branch server 102 to which the user preferably logged in to attain a user entitlement level and user preference profile. If this information is unavailable, shell-init module 88 will point to the master entitlement server 116 to attain a user entitlement level and user preference profile. Shell-init will always point to branch server 102 for, e.g., financial adviser specific client data, SMTP e-mail, etc.

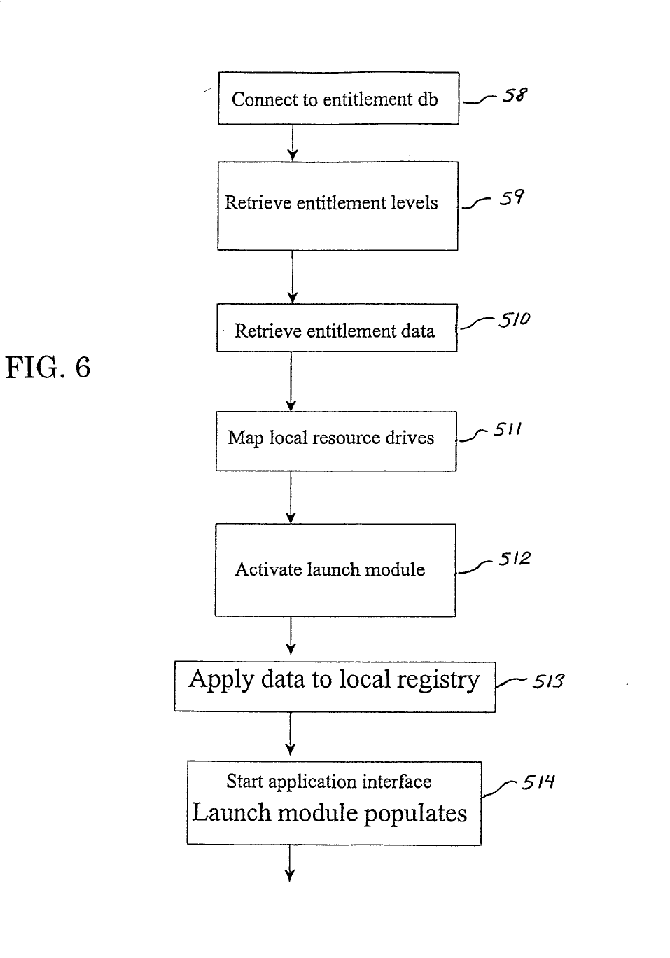

Next, turning to FIG. 6, at step S8, shell-init module 88 connects to an entitlement database, located on a server within system 10. Access to user entitlement level is based on the user identity input at authentication. Shellinit module 88 attempts first to access a user's branch database 106, which includes an entitlement database, to determine this information. If unable to do so, system 10 has a failover to a central server 110 master entitlement database maintained in master entitlement database 116. The master entitlement database includes duplicate entitlement databases to those in the branches.

Next at step S9, shell-init module 88 retrieves a user's entitlement level. In particular, shell-init module 88 retrieves a list of user identifications for accessing objects from system 10. These identifications are stored for use by browser interface 200.

At step S10, shell-init module 88 logons onto an appropriate server, e.g., branch server 102 or central server 110, and retrieves entitlement data. Shell-init module 88 secures registry entries for browser interface 200, attains a user control list, a batch file for interface launch module 90, and a user's parent branch wire code.

Next at step S11, shell-init module 88 maps a user's workstation local resource drives to a user's directories/files, i.e., distributed file system (DFS), by reading from the user's preferences and substituting variables with wire codes, branch groups and user names as appropriate. DFS may be located in any of host server 100 component servers.

At step S12, shell-init module 88 activates browser interface launch module 90, which runs throughout a user's session. Interface launch module 90 builds browser interface 200 from a user's standard browser, and handles security ticket expiration, user logoff and workstation 20 restorations. With special regard to security ticket expiration, launch module 90 continually monitors a security time ticket and gives a warning to a user when time is about to expire. This functionality is provided by querying password module 92 to determine what time allotment a user may have.

Next at step S13, launch module 90 applies the entitlement data to the local workstation registry, i.e., it removes the local preference profile of the workstation and/or browser the user is using. Thereafter, launch module 90 signals controller 84 to start browser interface 200.

At step S14, controller 84 starts browser interface 200, and launch module 90 populates the user's browser with the user's entitled objects and any other ancillary processes. During this time, launch module 90 retrieves path names of executables to launch from the registry. Some objects execute and are monitored, some execute but are not monitored, and some execute at to logoff. These are monitored by launch module 90 so appropriate action may be taken.

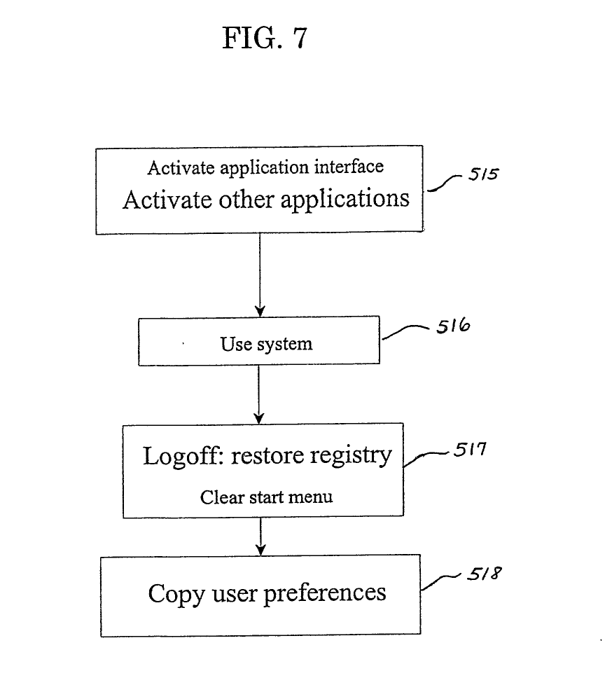

At step S15, shown in FIG. 7, launch module 90 activates browser interface 200, which in turn activates all other objects according to a user's entitlement data.

At step S16, the system is used to conduct various finance-related activities such as advising investors, conduct exchanges on behalf of an investor, chart investment progress, or the like. In this way, the user can provide the investor with timely, proactive financial advice. Launch module 90 monitors a user's time versus a security ticket expiration and notifies a user when his or her time is about to expire. The notification may provide a user with the ability to extend the ticket, otherwise, the user will be forcibly logged off.

At step S17, a user logs-off the system, at which time launch module 90 restores the workstation registry entries that were in place prior to the user's sessions and clears the user's browser.

At step S18, controller 84 copies a user's preferences from local cache to the location from which it attained them as appropriate so a user's changes can be accessed the next time the user logs on.

The authentication system 80 thus described allows a user to access objects according to entitlement level and provides a user preference profile for that user regardless of where workstation 20 is physically located. As such, the system 80 allows a user to log-on from any Internet accessible computer or workstation 20 and have all of the objects, directories/files and preferences available as if they were at their own workstation.

IV. Browser Interface

FIGS. 8A-38 illustrate a browser interface 200 of the invention. Using browser interface 200, a user may access the features of system 10 in a completely Internet-based environment. In this environment, a user may access objects such as those outlined above in section II (i.e., as shown in FIG. 3, a plurality of financial applications 36, a plurality of market monitoring objects 38, and a plurality of additional objects 35), from any personal computer or workstation 20 having Internet access. The ability to have a user access the system using a browser interface 200 provides an advanced technology platform with a stable, fast operating environment, easy accessibility and usability, and the flexibility of remote computing.

Advantageously, browser interface 200 provides a seamless transition between the different objects afforded by system 10 of the invention. The objects available are determined by a user's entitlement level as described above relative to authentication system 80. Browser interface 200 thus acts as a “controlled shell” for a user in that only objects that a user is entitled to are provided to him or her. Based on the type of financial information desired, the user selects the appropriate application(s), function(s) or Web site(s)/page(s) for use, as described in greater detail below. In accordance with the particular user selection, system 10 opens and/or connects to the selected object(s) and the user is able to view the object(s) at workstation 20 through the browser interface 200. Object data displayed may be from any component server of host server 100, i.e., branch or central servers. Access to Internet investment product server(s) 124 or any other outside source that requires heightened security, may be accessed (or filtered) through firewall 120 from the Internet 121 (FIG. 1).

As discussed above relative to system 10, where a user is connected to a host server 100 via the Internet 21, connectivity is provided by conventional TCP/IP sockets-based protocol. In this network-based system, a workstation 20 may be any computer, stationary or portable as described above, that has Internet access such as an Internet service provider outside of the system 10 to establish connectivity to host server 100 of system 10. In this environment, all data is preferably encrypted, e.g., with 128-bit encryption techniques, to ensure account integrity will be maintained.

Referring to the details of FIGS. 8A-38, an exemplary browser interface 200 is described. It should be recognized that the particular objects disclosed may vary depending on a user's entitlement level. Furthermore, the particular appearance of browser interface 200 may vary according to a user's preference profile, e.g., each user's toolbar may have buttons in different positions, have different objects viewable from a menu, etc.

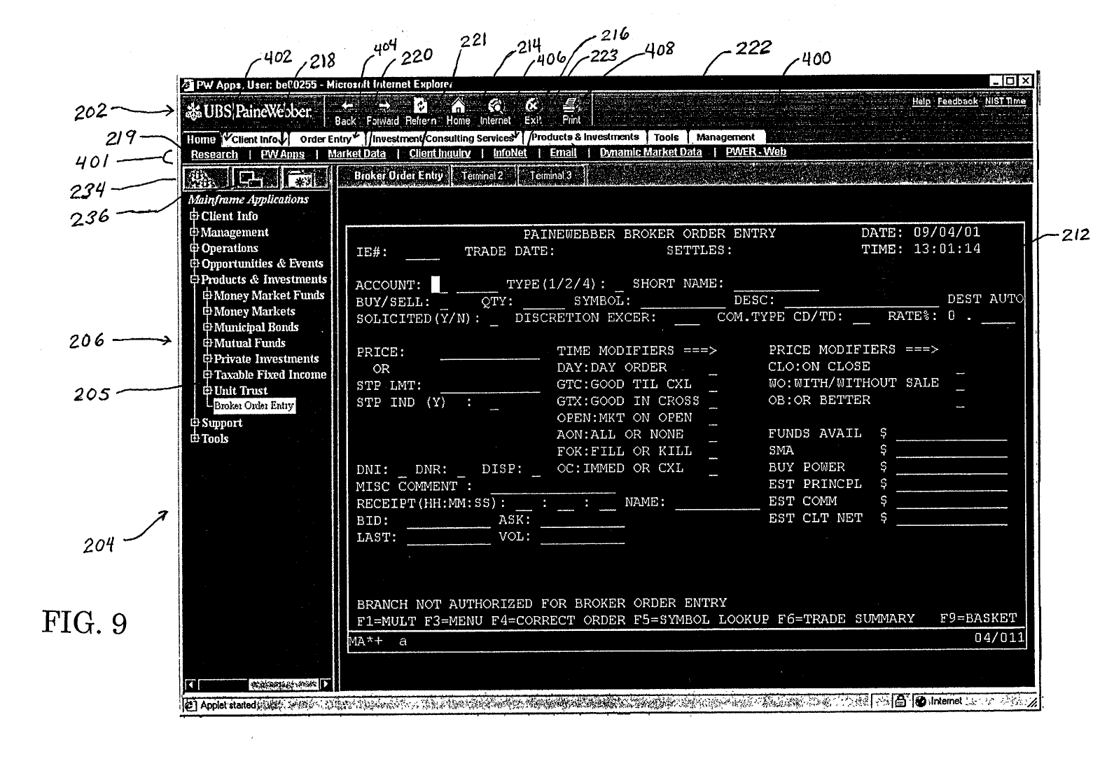

Referring to FIG. 8A, an authentication login 222 is displayed on a user's browser. Login 222 is presented to a user upon accessing system 10 by inputting an appropriate URL in the user's browser, and is operable with authentication system 80 of system 10, as discussed above, to allow a user to enter system 10 using his or her user name and password. Where a successful logon has been completed, the user is presented with a browser interface start window 201 such as the simplified screen display of available feature shown in FIG. 8B. As used herein, the interface 200 shown in FIG. 8B is a simplified version to that shown in FIGS. 9-38 and is not representative of the complete feature set of browser interface 200.

Referring to the more detailed drawings in FIGS. 9-38, the browser interface 200 includes:

a navigation toolbar 202;

a task menu 400;

an object menu 401;

an action menu 204; and

at least one view window 212.

Toolbar 202 may include standard browser features such as back, forward, refresh/reload, home and print. Additionally, toolbar 202 preferably includes an Internet selection 214 and exit selection 216. Internet selection 214 allows a user to access the Internet in general for conventional search engine searching of the World Wide Web. For example, a user may conduct searches for investment information, background information, breaking news that affects investments and the like on search engines as Yahoo and Excite. General Internet access also allows a user to communicate with other users and with clients via e-mail packages such as provided by Microsoft Outlook. This provides means to access the Internet, send e-mail and search at least one search engine. If necessary, access to the Internet 121 may be filtered through firewall 120 of system 10 for added security. Exit selection 216 to allows a user to successfully logoff of system 10.

The toolbar 202 also preferably includes a scratchpad application selector 207, which serves to maintain focus on accounts or positions by moving information between objects of system 10. Accordingly, scratchpad 207 relieves the user from having to continually re-enter data. Although preferred toolbar features have been disclosed, it should be recognized that any number of additional features and/or selections might be added in a known fashion as desired.

The task menu 400 is preferably presented as a series of command tabs, each of which provides access to different objects or features of the browser interface 200. The task menu organizes the system features by the broad tasks that a user, such as a broker or financial analyst, encounters in performing their daily activities.

The object menu 401 provides the user with a user-selected link to each financial application or information resource that is associated with the task 400 presently selected by the user. Each task 400 is associated with a different object menu that is viewable when that task is selected by the user.

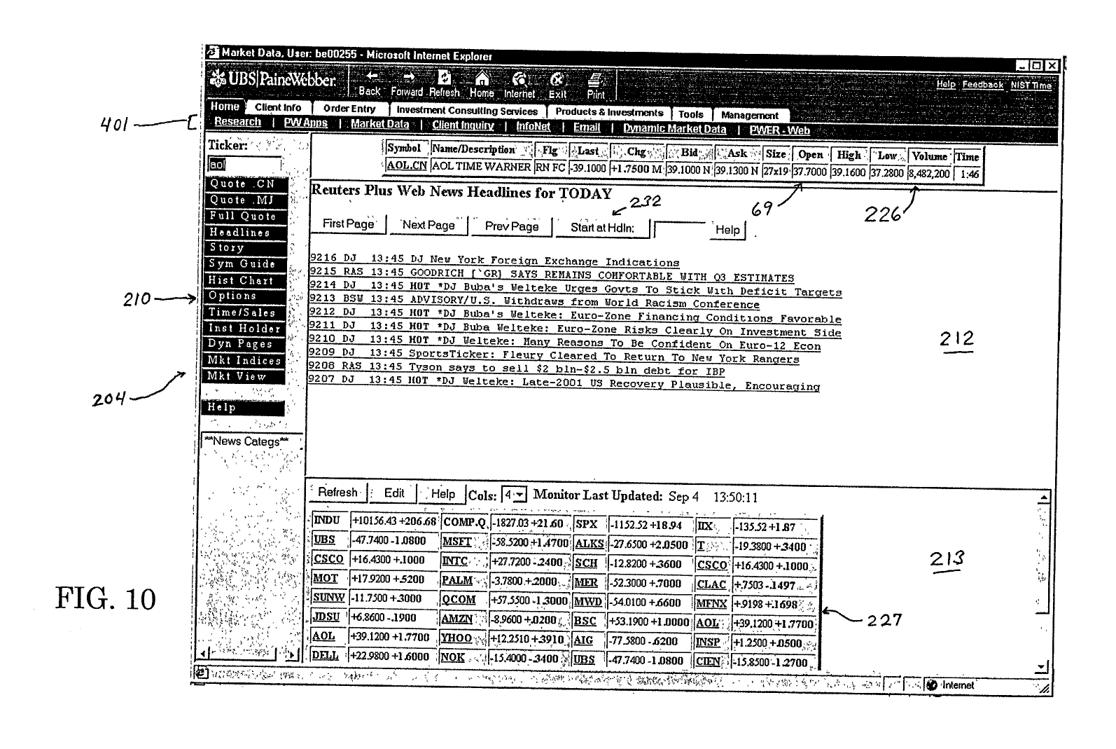

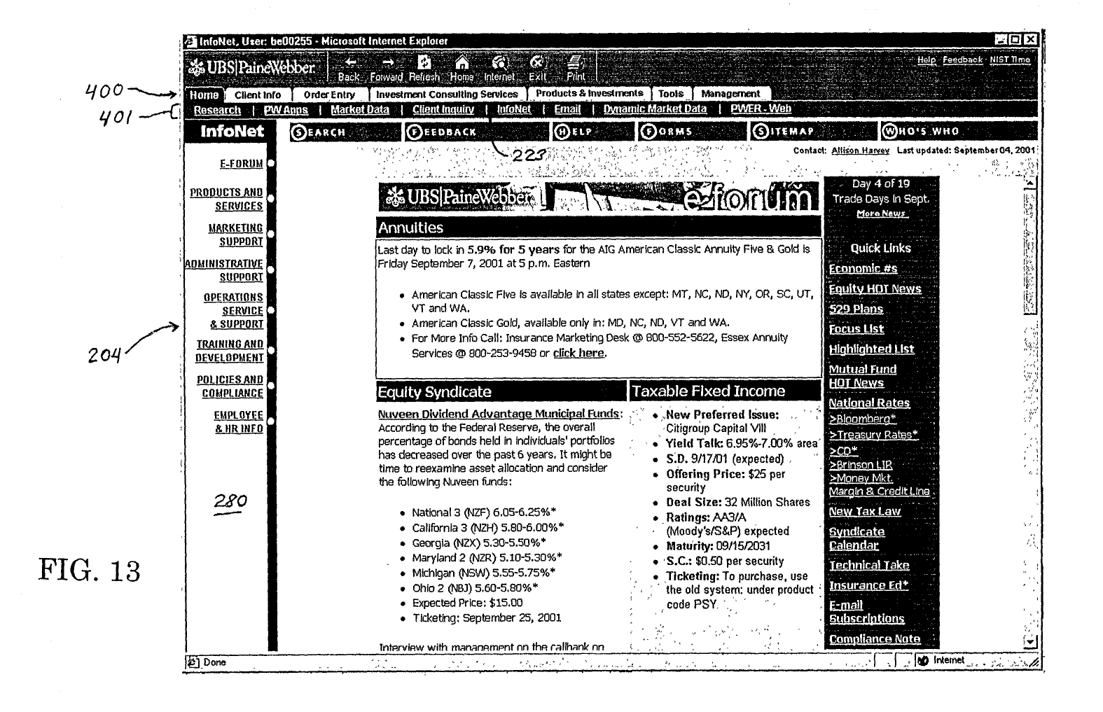

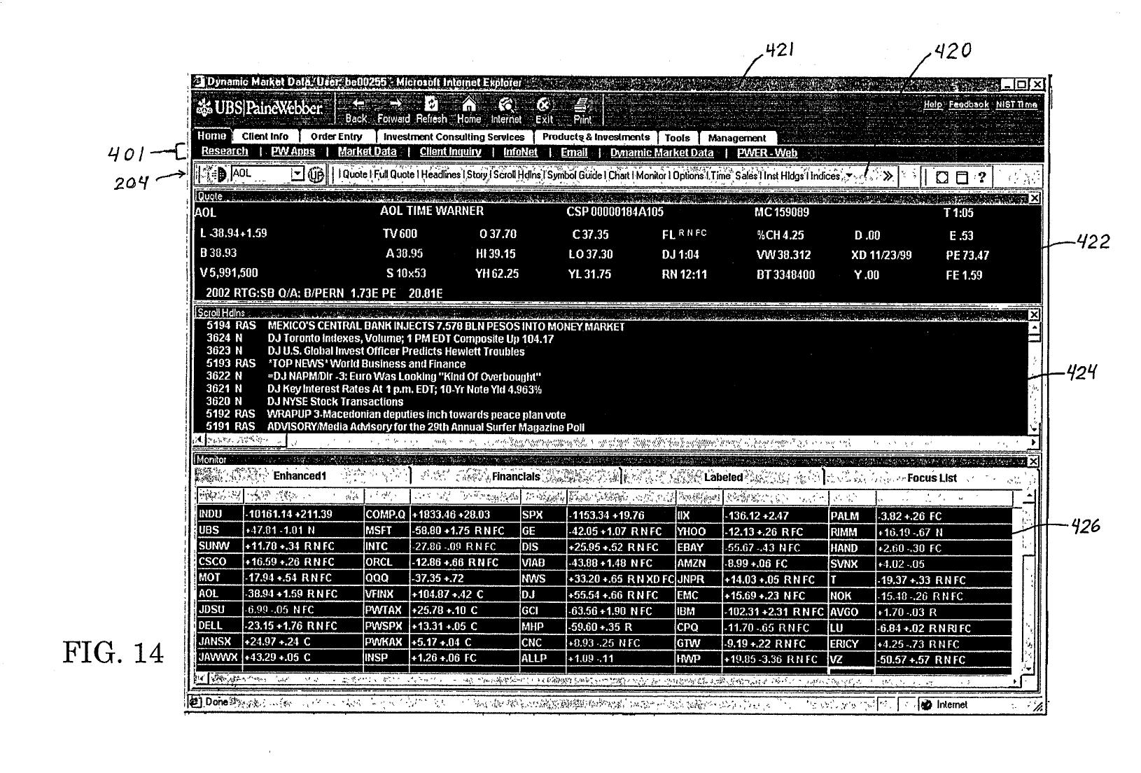

The action menu 204 varies depending on the object 401 selected by the user. In one case, as shown in FIG. 9, the action menu 204 presents a menu of application operations (i.e., application menu) 206. In another case, as shown in FIG. 10, the action menu 204 presents a market data function menu 210. In still other cases, the action menu 204 can be a navigation menu 280, as shown in FIG. 13. The action menu 204 can be positioned at a variety of positions on the screen, such as the width-wise position of the operation menu 420 shown in FIG. 14. The view window 212 is used to present information from the associated object(s) selected by the user.

Using the above-noted task bar 400 and object menu(s) 401, a user may select an application, function or information resource presented by browser interface 200. Upon activation of any selection, browser interface 200 typically provides the action menu 204 of possible actions, operations, functions or information content available for the particular selection. Upon selection of an object, the information associated therewith is displayed in at least one view window 212. If the object activated does not contain a number of user-selectable actions thereby obviating the need for a menu, the view window 212 may display the information without an associated action menu. Each entry in the action menu 204 can be a hypertext link to a function or other object having information for display or a link to a menu 205 of sub-items, e.g., as shown for products & investments in FIG. 9. Selection of a particular operation from menu 204, 205 will force activation and/or display of the associated information in at least one view window 212 adjacent to the action menu 204.

As shown in FIG. 10, more than one view window 212, 213 may be displayed at one time by selecting split screen function 236 (FIG. 9) and activating multiple objects. For instance, in FIG. 10, a first view window 212 displays a market data headlines view function 226, while a second view window 213 displays a market data monitor list function 227. Similarly, one view window 212 may display a market data function, while a second view window 213 displays a financial application. Every view window 212, 213 may include conventional scroll bars as necessary.

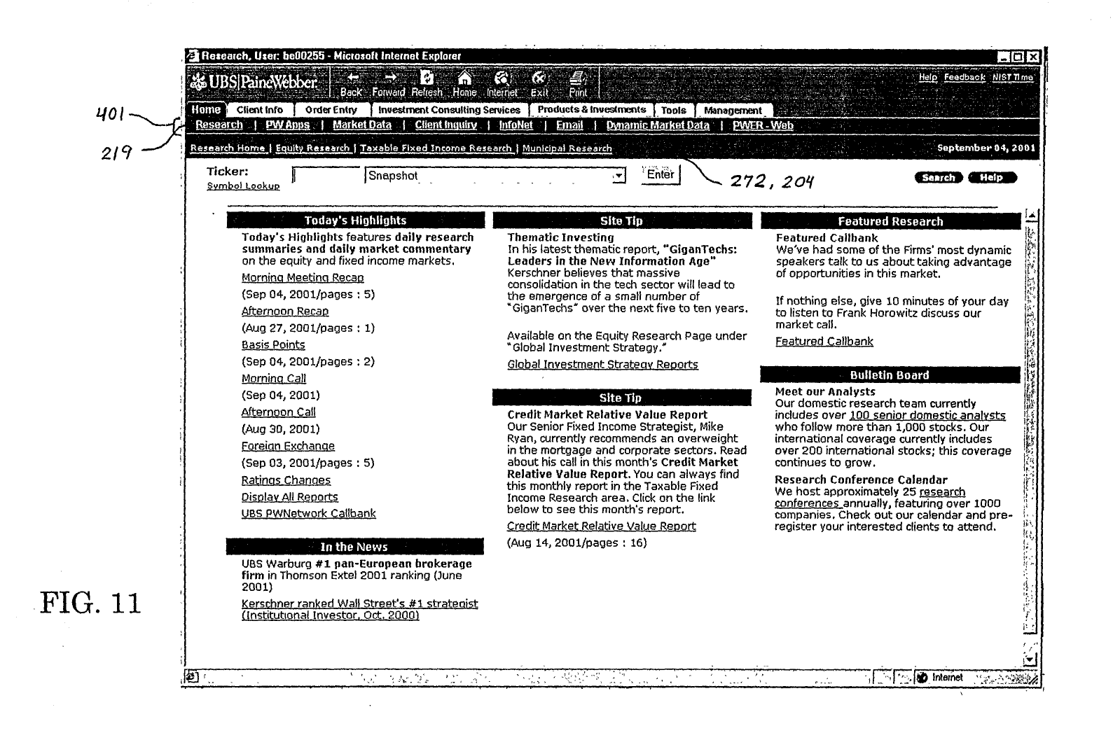

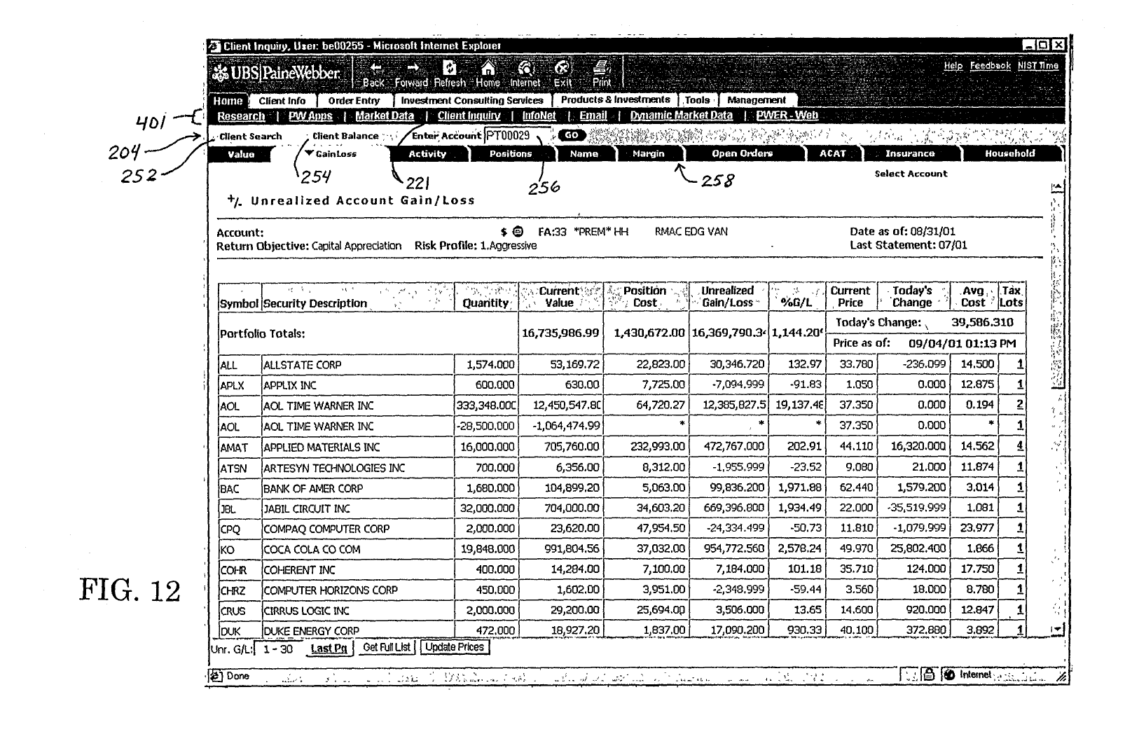

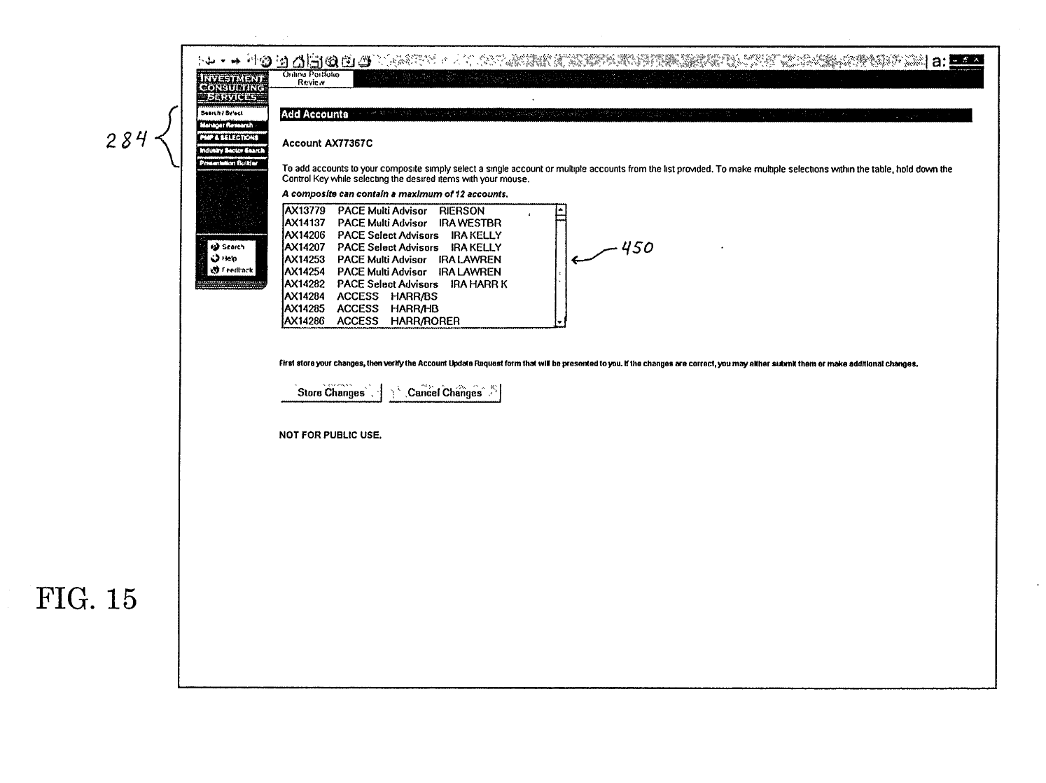

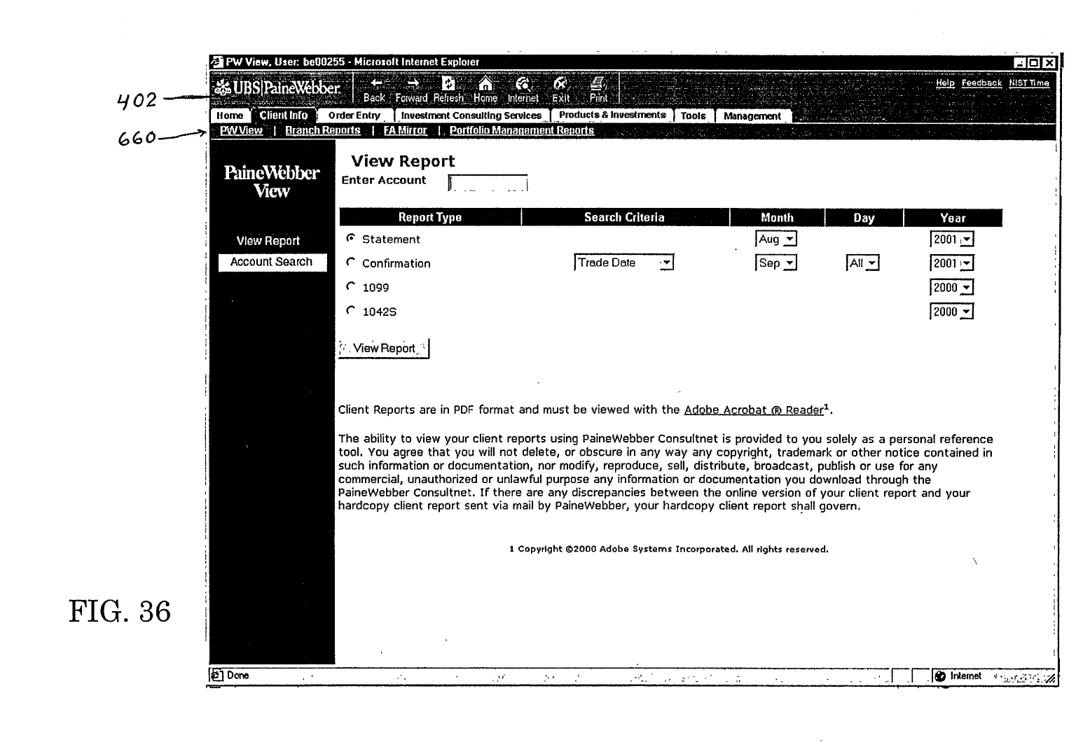

The following description sets forth exemplary features of browser interface 200 such as financial application objects 36, market monitoring functions 38, additional objects 35, and additional browser interface features. The application objects may include research objects for researching investments (FIG. 11); client inquiry objects for investigating client accounts, positions, and the like (FIG. 12); a browser-based information network that provides proprietary product and administration information (FIG. 13); dynamic market data (FIG. 14); various objects for investment consulting services (FIGS. 15-35); and a variety of other objects (FIGS. 36-38).

A. Main Menu

A.1 Applications:

FIG. 9 shows the action menu 204 instantiated as an application menu 206 for a plurality of functions or operations provided upon activation of the “PW Apps” link 218 on the object menu 401. These functions generally provide investor account data, online statements, transaction confirmation, IRS 1099's, investor account information, portfolio management, TFI and MUNI inventory, security cross references, and the like. The selections of application menu 206 may include client information functions, management functions, opportunities and events functions, products and investment functions, support functions, and tool functions. Each selection may include a drop-down menu 205 of subselections. For instance, product and investment sub-selections include money markets, municipal bonds, mutual funds, private investments, taxable fixed income, unit trust and broker order entry. FIG. 9 shows a broker order entry function in view window 212 that has been selected from application menu 206.

Exemplary sub-selections for some of the application selections include:

Client info: account inquiry, householding of a family or related accounts, online client services, portfolio management, client contact and portfolio information, security cross reference, stock records, 1900 system, client database, client and account review, client statement system, dividend reinvestment, late pay-margin interest, managed account billing, client account balances (i.e., MoneyLine), and financial framework (a financial planning application). One particular ‘client info’ application is an investor monitoring system which allows a user such as a financial adviser to monitor specified investor accounts and activity, e.g., online investor transactions, and allows the user to monitor and participate in investor-mediated transactions on a real-time basis. For instance, after tracking an account activity, a user may send e-mail to a client and make recommendations. Further, a user may place orders and conduct other transactions for a client via applications menu 206, e.g., placing an order as shown in FIG. 9. Here, host server 100 is linked via conventional communications channels to a system for investor trading such as an online transaction forum, or some other investor transaction system such as a telephone-assisted investment forum. In such instances, host server 100 receives real-time communications regarding investor-mediated transactions. These are, in turn, transmitted to a user's workstation 20 on a to real-time basis over Internet 21. Because the user is notified of an investor's transaction status, he or she can intercede and/or act in a proactive manner; for example, by contracting the investor if it appears that the investor needs assistance with a transaction. In this way, the user can protect an investor outside of the system of the present invention from executing deleterious financial transactions. The monitoring system also alerts a workstation 20 within the system where an investment transaction forum, such as those described above, blocks an investor from entering an investor-mediated transaction, or alternatively allows an investor to successfully complete a particular transaction.

Management: trade monitor operations problem ticket tracking and reporting system, and client account cross reference lookup/routing used to maintain audit of account number changes.

Opportunities and Events: new and old corporate actions; a financial adviser may view his or her client account balances (called FYIE), maturing holding, commissions revenue history, etc., and an enhanced version of ME that provides the financial adviser with upgrade recommendations for his clients particular to swap or upgrade security recommendations.

Support: account maintenance fee, aged check system, disbursement confirmation system, fed funds transfer system, messages, securities information inquiry and security glossary lookup.

A.2 Market Data:

FIG. 10 shows the action menu 204 instantiated as a market data function menu 210, which is provided upon selection of the market data link 220 on the object menu 401. Market data function menu 210 provides a plurality of market data functions for selection. Generally, market data functions may provide real-time access to quotes (e.g., last, bid, ask, NASDAQ, Commodities, etc.), news, historical information (e.g., daily, weekly), charting, dynamic market indicators (e.g., percent up and down, point gainers and losers, foreign exchanges, financial futures, most active trades and the like), news from popular services and the Dow Jones, market views, a fixed income calculator, symbol guide and news and limit alerts as well as the ability to customize charting features and web pages.

Each market data function presents real-time market data in a useful manner. The market data function menu 210 includes a number of functions that allow a user to review market data. For example, a user can obtain headlines, and specific information on a security such as a quote, full quote, today's headlines, options, time and sales, institutional holders, and the like. Other optional information such as a market snapshot of indices, market view, an overview of several exchanges (i.e., NYSE, NASDAQ, and AMEX), sector quotes, and news categories may also be accessed. Historical charts can be also plotted for a given security. Preferably, the market data functions access market data server 114 (FIG. 1) on a real-time basis, e.g., one that accesses Quotron by Reuters. As previously noted, the market data functions may access other market data servers, maintained as part of branch server 102. The information may be updated by clicking on a refresh button on toolbar 202.

Using mechanisms well known to those with skill in the art, any relevant market information may be accessible within the market data functions. For instance, FIG. 10 shows a market data function's headlines function view window 226 for the stock AOL.

Advantageously, the market data functions permit customization of any of the displayed information and allows for multiple representations on a single screen. As shown, each view window 212, 213 may also provide functionality selections 232 particular to that view window.

Once connected, data flows in real time to the user's market data functions. Changes are indicated on screen and the user has the ability to set options such as colors, font sizes, audible alerts, blinking, etc. that will be saved as part of his or her preference profile. The receiving of the market data updates is frequently called “dynamic, real-time, streaming quotes”. Once the user obtains financial information of interest, he or she can utilize this information to advise an investor, conduct exchanges on behalf of an investor, chart an investor's investment progress, or the like. In this way, the user can provide the investor with timely, proactive financial advice.

An additional functionality of a market data function may include a customized quote window 69, which may contain information such as last price, bid, ask, high, low, etc. Quote window 69 may be continuously displayed on video display 24 as part of browser interface 200, i.e., it is fully integrated into all data displayed from any component server of host server 100 from which data is retrieved or sent. The symbol in the quote window 69 may also be dynamically linked to the symbol focused on by a user's cursor, or mouse 28.

A.3 Research:

In FIG. 11, the action menu 204 is instantiated as a research menu 272 that is provided upon selection of the research link 219 from the object menu 401. Research menu 272 includes a number of research functions for researching investment information. Exemplary research menu 272 selections include main menu or home, equity research, taxable fixed income research, and municipal research. A exemplary research function is the proprietary PaineWebber PWER II system, which searches for companies by, for example, industry, price, P/E ratio, growth rate and rating, utilizing multiple search methods such as by date, author, title, industry, subject code, ticker system, company name, report type and country.

A.4 Client Inquiry:

In FIG. 12, the action menu 204 is instantiated as a client inquiry menu 250 that is provided upon selection of the client inquiry link 221 from the object menu 401. Client inquiry object selections allow a user to search for a client 252, obtain a client balance 254 and select an account 256 for investigation. A user may also evaluate an account in a variety of ways through account evaluation menu 258, which also forms part of action menu 204. Menu 258 may include evaluation selections of, for example activity, unrealized gains/losses (shown in FIG. 12), statement household (i.e., client specific account categorization), insurance, realized gains/losses and value.

A.5 InfoNet:

In FIG. 13, the action menu 204 is instantiated as an information network (called InfoNet) navigation menu 280 that is provided upon selection of the “InfoNet” link 223 from the object menu 401. FIG. 13 also shows a start Web page for InfoNet. InfoNet is a proprietary browser-based information network that enables users to conduct searches for ideas and information, provides links to related pages (for example, a sales idea, a marketing brochure, etc.), provides subscriptions to popular publications and research, access to third-party news, information and sales ideas, and allows a user to fill out and forward forms to an investment forum outside of the system 10. In particular, the InfoNet menu 280 may provide selections for an E-forum for employees, corporate products and services, marketing support, administrative support, operations support, training and development, employee information, policies and compliance and correspondent service corporation.

A.6 Dynamic Market Data:

In FIG. 14, the action menu 204 is instantiated as a market data menu 420 that is provided upon activation of a dynamic market data link 421 from the object menu 401. The market data menu 420 enables the user to select a particular equity and obtain a variety of information about it, such as a real time stock quote 422 and stories pertaining to the stock. The user can also select to see a variety of the most recent financial news headlines 424 obtainable from one or more third party or internal sources; set up and monitor a plurality of stocks 426; obtain detailed news stories about a stock via menu selection 428; and chart a stock via menu selection 432.

B. Investment Consulting Services

B.1 Online Portfolio Review:

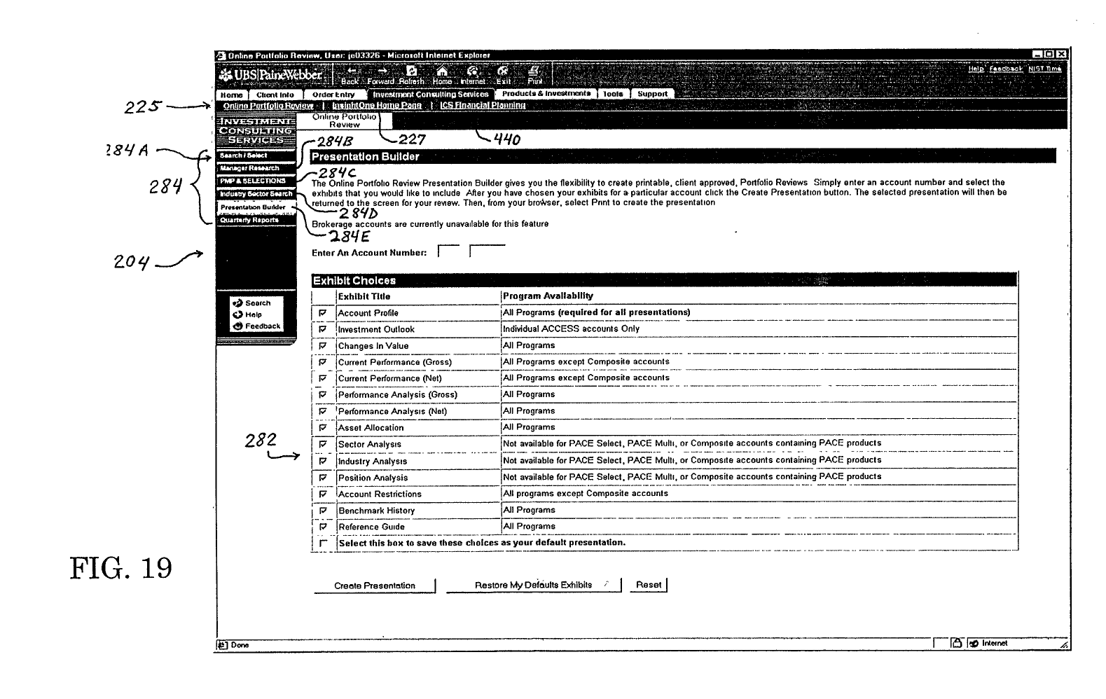

FIGS. 15-31 show various links available under the investment consulting services (ICS) tab 406 of the task menu 400 (seen in FIG. 9 and FIG. 19). These links provide access to the following objects: an online portfolio review application 225; Insight One™ web site 227; ICS financial planning application 440; and ICS trading application 442.

The online portfolio review (OPR) application 225 provides users with enhanced client reporting over daily and extended timeframes, and provides a tool that reflects asset allocation for grouped or composite accounts. It also compares account holdings to selected indexes. The OPR application may be used for both managed accounts, e.g., by a financial advisor, and non-managed accounts. Preferably, the OPR application is used for managed accounts. FIG. 19 illustrates an action menu 204 instantiated as an online portfolio review menu 284 that is provided upon activation from the online portfolio review application 225 on the object menu 401. From portfolio review menu 284, a user may select functions such as:

Search and select (284A)—enables a user to select one or more accounts and invoke a number of portfolio review functions to create exhibits, for example, client presentations.

Manager research (284B)—provides information about product managers.

PMP & Selections (284C)—a portfolio management program.

Industry sector search (284D)—for obtaining exhibits regarding a particular industry sector.

Presentation builder (284E)—creates presentation exhibits based on a client portfolio.

More specifically, the search and select function 284A enables users to create composite accounts, as shown in the screen shot 450 of FIG. 15 wherein an analyst or other user has created an example composite account no. AX77367C. A composite account groups together related accounts across various financial products to create a single householded account.

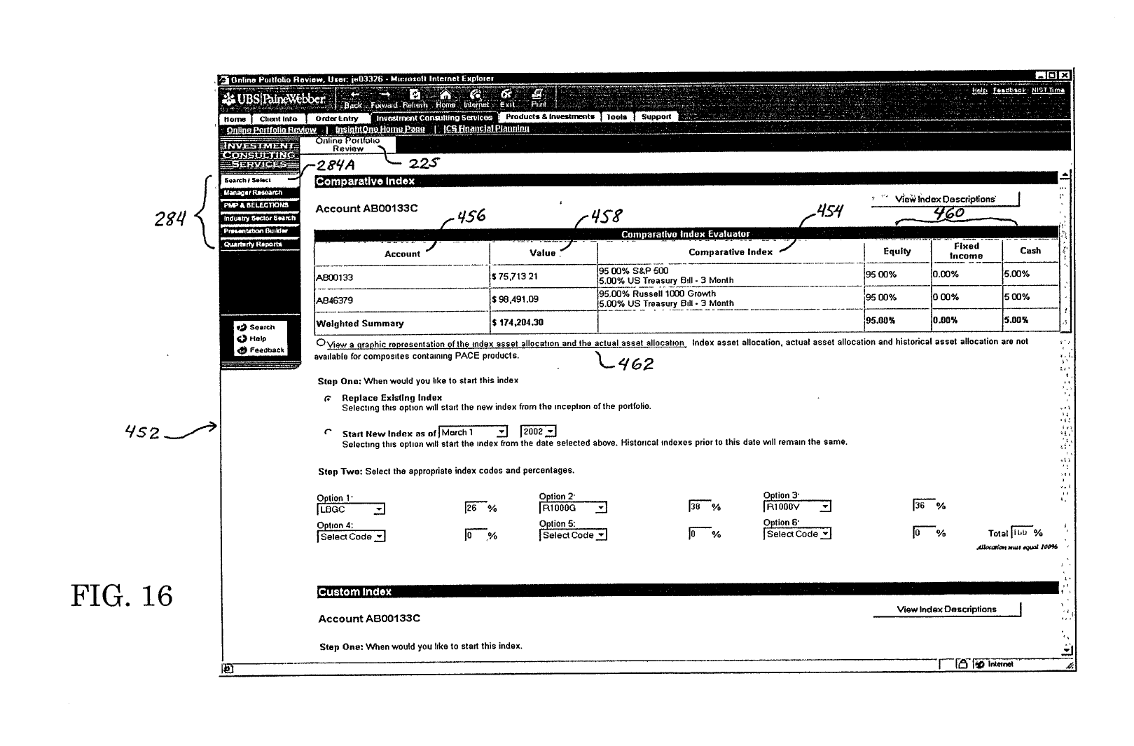

Bringing unique accounts together presents a difficulty in terms of choosing a representative comparative index which can be used to evaluate the composite account. This is rectified by the search and select function 284A which allows the user to select a comparative index evaluator 454, as shown in the screen 452 of FIG. 16. The screen 452 displays the account number 456, value 458, comparative index 452 [454?], and the index classification 460. From this screen the user will be able to select a comparative index based on the information displayed, and will also have a hyperlink 462 to view a graphical representation of asset allocation.

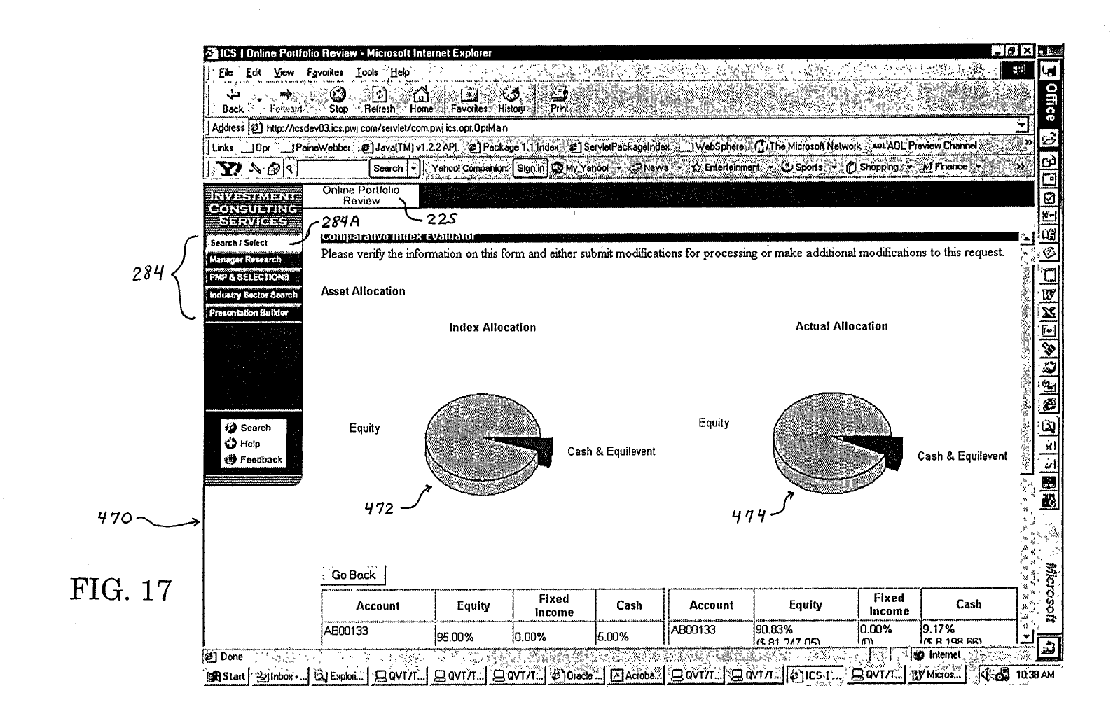

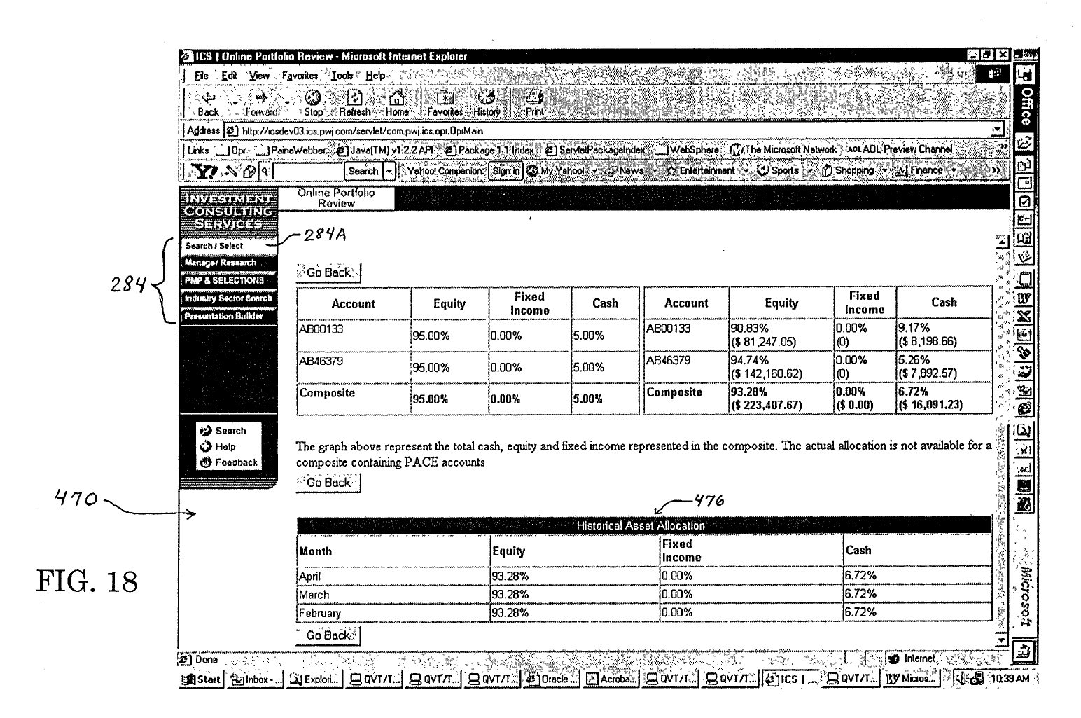

If the user chooses to view the graphic representation, the user will be brought to an asset allocation evaluation tool 470, depicted by the screen display of FIG. 17. FIG. 17 graphically represents (using a pie chart in this case) the asset allocation of the selected index 472 and of the composite account 474. FIG. 18 shows a continuation screen of the asset allocation tool 470, wherein the asset allocation is tabulated, as shown. Historical asset allocation 476 may also be stored and presented.

The presentation builder feature 284E provides the user with printable portfolio reviews. Examples of the types of displayable and/or printable reports (alternatively referred to as exhibits) 282 are shown in FIG. 19.

Another aspect of the presentation builder tool is that it also enables financial advisors to select and assemble marketing and advisory materials from a wide range pre-selected materials relating to a variety of product areas into customized slide presentations for clients and prospective clients. The tool enables financial analysts to increase the number of presentations to clients while reducing the time and effort required to accomplish this.

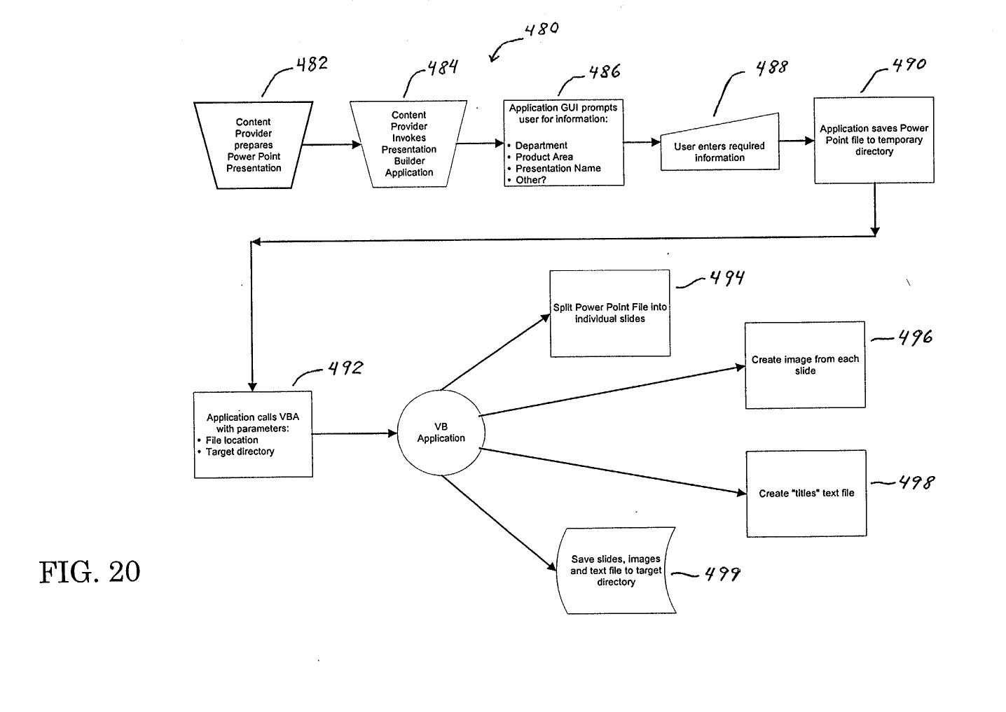

FIG. 20 shows a process 480 for uploading slides to a centralized database. Certain users have rights as “content providers” which enables them to load presentations into the presentation builder database. A presentation is created in Microsoft Power Point™ (step 482), and uploaded as a power point (PPT) file to a temporary directory along with tombstone information entered by the user (steps 484-490).

The tool then calls a visual basic application (step 492) which splits the file into individual slides (step 494) and creates a separate image from each slide (step 496). This allows the tool to display and manipulate the slides individually. The tool reads each slide's title from the “title” object embedded in every PPT slide and creates a corresponding text file (step 498). If the “title” object is empty, a system-generated title will be used. Once the slides are loaded in the database, they can be accessed to create customized presentations.

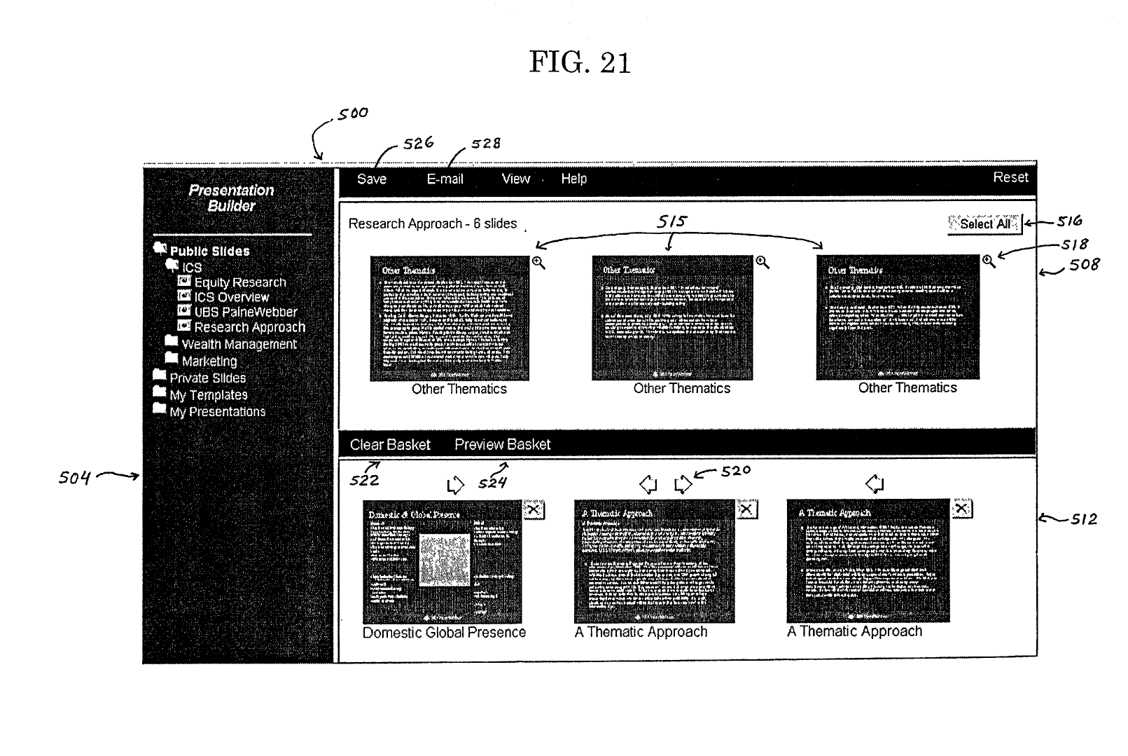

FIG. 21 shows a slide display screen 500, which comprises three main panels: a folders panel 504, a slide selection panel 508 and a basket panel 512. The slide selection panel 508 shows images of the slides in the presentation selected by the user from a public slides folder or a private slides folder. The name and number of slides of the selected presentation are shown on the upper left corner of the panel. This text will also indicate if the presentation is “grouped”.

Users click on a slide 515 to select it. A selected slide is automatically transferred out of the slide selection panel 508 and into the basket panel 512. The “Select All” button 516 on the upper right corner will transfer all the slides in the slide selection panel 508 to the basket panel 512. Once done selecting slides from one presentation, users can open and select slides from another presentation.

The illustrated embodiment shows that the user opened a presentation entitled “Research Approach” from the ICS sub-folder in the Public Slides folder. This presentation contains 6 slides. Of the six slides, the user selected three, which are shown in the basket panel.

Users can enlarge each slide in the selection panel by clicking the magnifying glass icon 518. A scroll bar will show on the slide selection panel 508 if the number of slides requires it.

The basket panel 512 contains images of the slides selected by the user from the various presentations available in the system. Except for the first and the last slides in the basket, each slide has two arrows 520 above it which allow the user to change the placement of the slide within the presentation. The arrow pointing to the right moves the slide to the next position. The arrow pointing to the left moves the slide to the previous position. Since the first slide in the basket can only move to the next position, it only has one arrow pointing to the right. Conversely, the last slide in the basket only has one arrow pointing to the left since this slide can only move to the previous position.

Options are also available for clearing 522 the basket 512, which removes all slides, and previewing 524 the basket, which allows users to navigate through magnified, or scaled down, images of the slides in the Basket Panel.

The save function 526 allows the user to save the presentations collected in the basket panel in either the “my presentations” folder or “my templates” folder, the latter being intended for temporary storage.

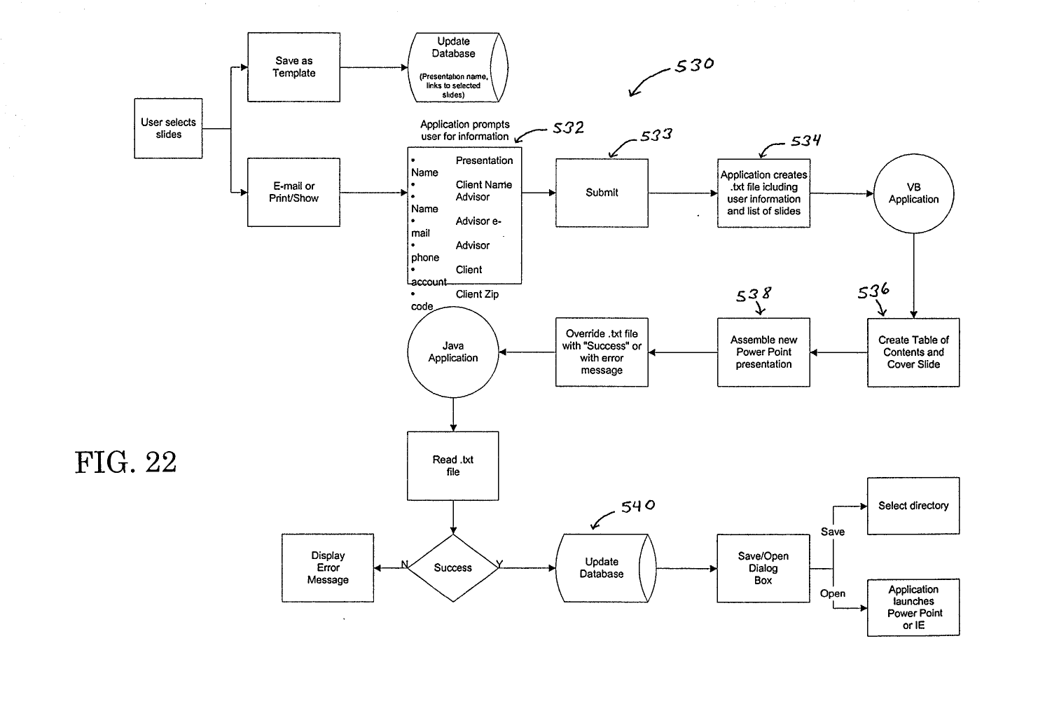

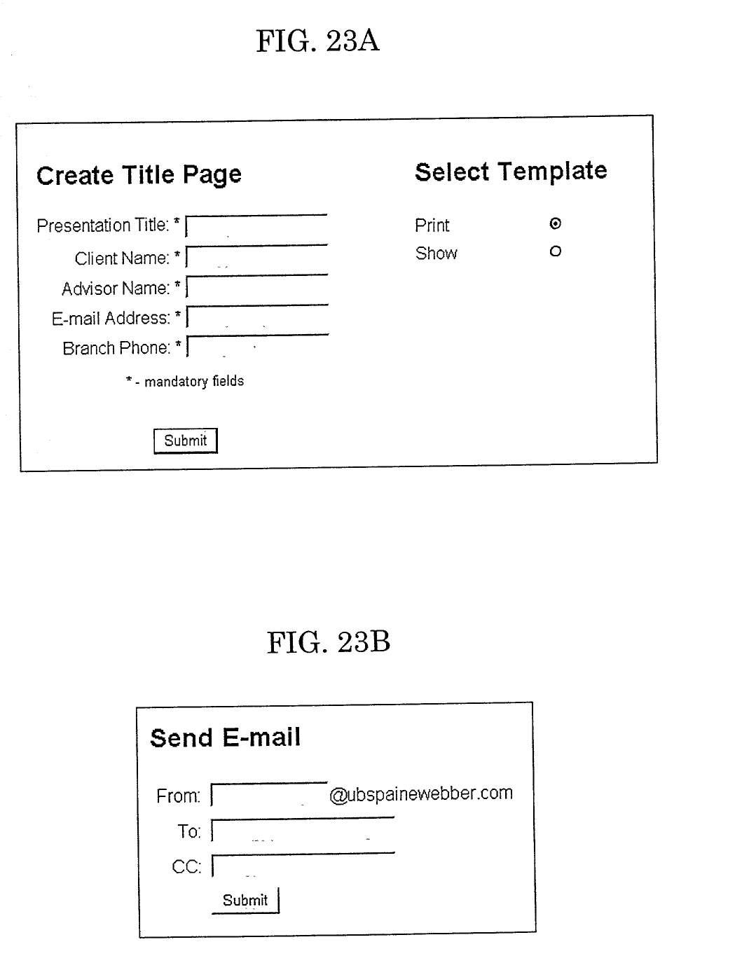

The e-mail function 528 allows the user to send a presentation to recipients via electronic mail. FIG. 22 shows the download process 530, and FIGS. 23A & 23B show various user-interface screens encountered to e-mail a presentation to a client.

In the event the user selects to e-mail, print or preview the selected slides, the tool will prompt the user for pertinent information such as presentation name, client name, advisor name, advisor e-mail, advisor phone, client account and client zip code, as shown in FIG. 23A and indicated at steps 532-534 in FIG. 22. Once the information is entered a “table of contents” slide and a “cover” slide are generated by the system (step 536). The application then proceeds to assemble the slides into one single Power Point file (step 538). If this process is successful the database is updated with client information (step 540).

Whenever a PPT file is created, the tool logs the user name, the date, the client's name, and the contents of the presentation (i.e., links to the slides included in the presentation) into its database for audit purposes (step 540). E-mails are also recorded.

B.2 InsightOne Web Site:

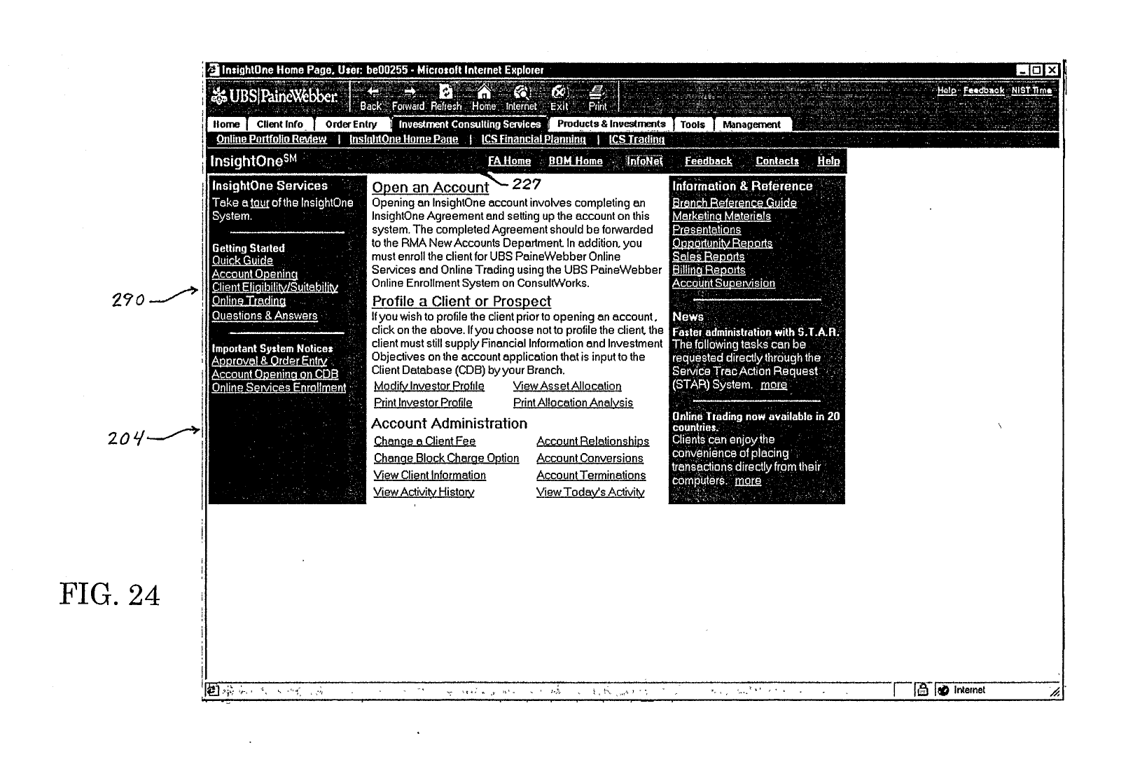

FIG. 24 shows the action menu 204 instantiated as an InsightOne menu 290 and web site home page that is provided upon activation of the InsightOne Home Page object link 227. InsightOne is a Web site that provides a non-discretionary client brokerage program that performs trade based on payment of a single annual fee calculated from eligible assets.

B.3 ICS Financial Planning

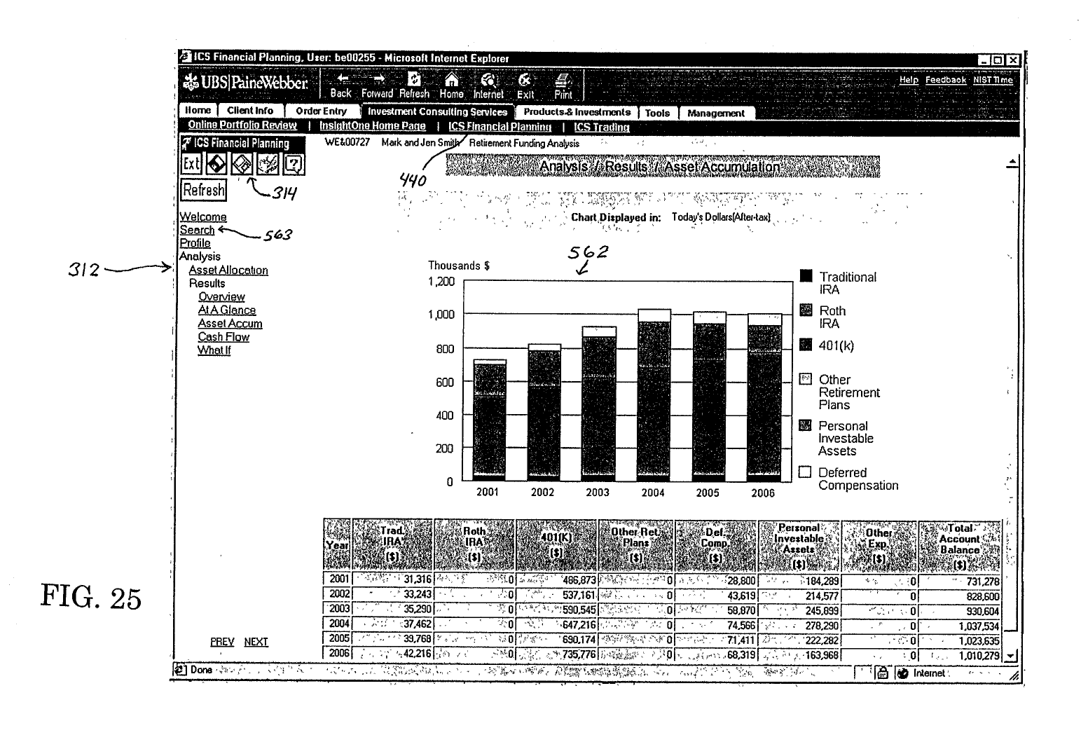

FIG. 25 shows a financial planning application 440 accessible via the object menu 401. Upon activation of this selection the action menu 204 is instantiated as a financial planning menu 312. The financial planning application enables through a user to profile clients and present appropriate asset allocations and investment alternatives. Financial planning application 440 displays an investor's current asset allocation and suggests an alternative allocation based on risk tolerance. It also analyzes progress toward goals using established growth rate assumptions; allows for customization of asset allocation and change in certain variables to assess the impact on an investor's financial situation; and allows for the assessment of the impact of inflation and other factors on investment results. The financial application can also be used for a retirement funding analysis, that is, to analyze the retirement savings and income needs of clients who are planning for retirement or who are already retired; for an education funding analysis, which address the funding needs for preparatory, undergraduate, and graduate schools; or other similar analysis.

The financial planning menu 312 provides selections to welcome a user and/or client and provides instructions on use of the application 440, search for client information, generate a client profile, and analyze a client portfolio. Under the analysis selection, a user may select from asset allocation to determine where a client has his or her investments and results. The results selection also includes selections such as overview, at a glance, asset accumulation, cash flow, and “what if”. “Overview” allows a user to generally review a client portfolio. “At a glance” provides a summary of the client portfolio. “Asset accumulation” provides a client's account(s) gains and analyzes progress toward goals using established growth rate assumptions. For example, FIG. 25 shows a chart 562 which projects asset accumulation over time on the basis of specified assumptions (not shown). The charts can be prepared based on composite or householded accounts in which an individual or family may have a number of separate accounts but wish to view the aggregate portfolio (i.e., across all accounts) over time. The user selects the accounts which form the basis for the chart via the “search” menu selection 563. “Cash flow” provides an indication of the liquidity of the client's assets. “What if” allows a user to suggest an alternative allocation based on risk tolerance. It also allows for customization of asset allocation and change in certain variables to assess the impact on an investor's financial situation; and it allows for the assessment of the impact of inflation and other factors on investment results.

Financial planning application 440 also provides icons 314 for exiting, saving, printing, help and refreshing the application.

B.4 ICS Trading (ICST)

ICST is a web-based application accessible from the ICS trading link 442 on the object menu 401. The application facilitates trade creation and allocation for users by streamlining navigation via browser based front-end screens. The ICST application gives users the ability to perform a trade criteria search by identifying particular accounts to which they may perform balancing functions by (a) single accounts, (b) security and (c) model balancing (by portfolio percentage). The ICST system also includes trading functions for manual order submission or electronic order submission (EOS), order execution and trade status capability.

Single account balancing allows the user to view the holdings in a single account and create orders by changing the target quantity. This results in an order quantity, for either buy or sell, which can be created and submitted. Security balancing is used by users to establish new or modified targets (holding %) for multiple accounts. For example, the user will identify all or a subset of accounts and specify that all accounts should hold 3.5% IBM. The holdings are analyzed relative to the target and orders to buy or sell are created at the account level and are blocked by security at execution time. Model balancing operations are used across or multiple accounts. Here, the user creates models that contain a list of securities and a corresponding weight (% to hold). When accounts are balanced against a model, the holdings and corresponding weight (relative to the portfolio) are compared with the securities and weights in the model. Orders to buy and sell are created as follows:

(1) securities in the model, but not in the account are bought. The quantity is derived from the weight in the model;

(2) securities in the account but not in the model are sold; and

(3) securities found in both the account an the model are adjusted to the appropriate weight, resulting in either a buy or sell.

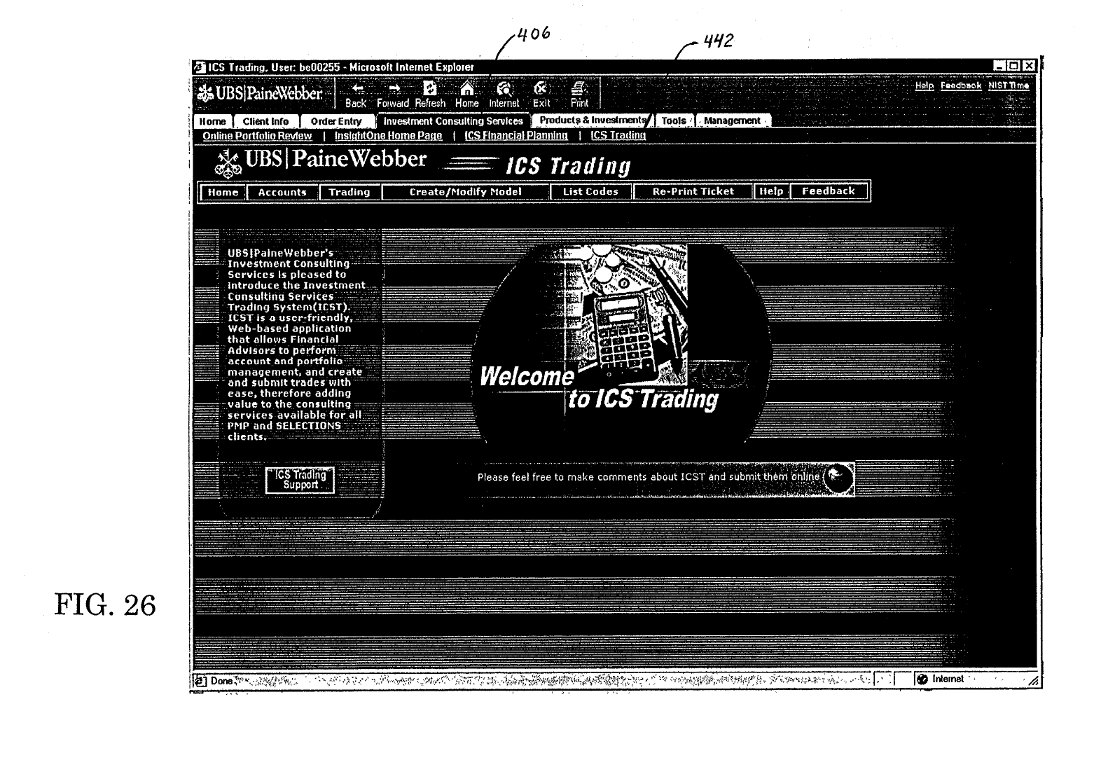

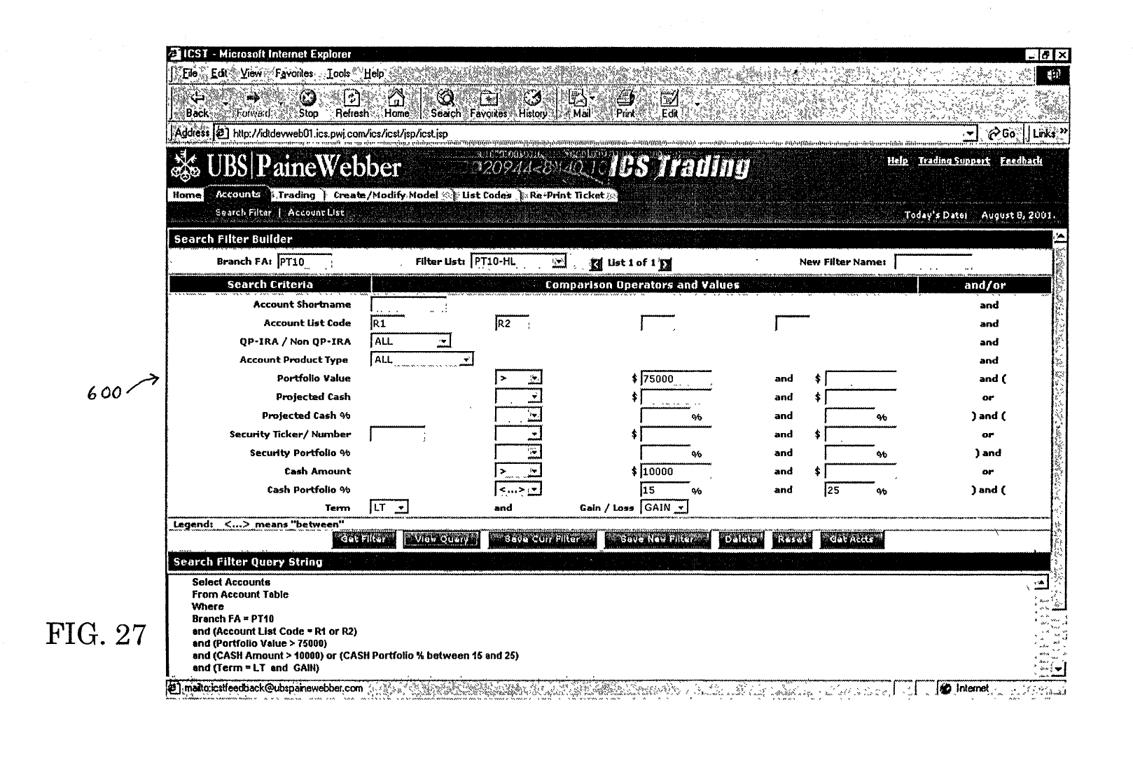

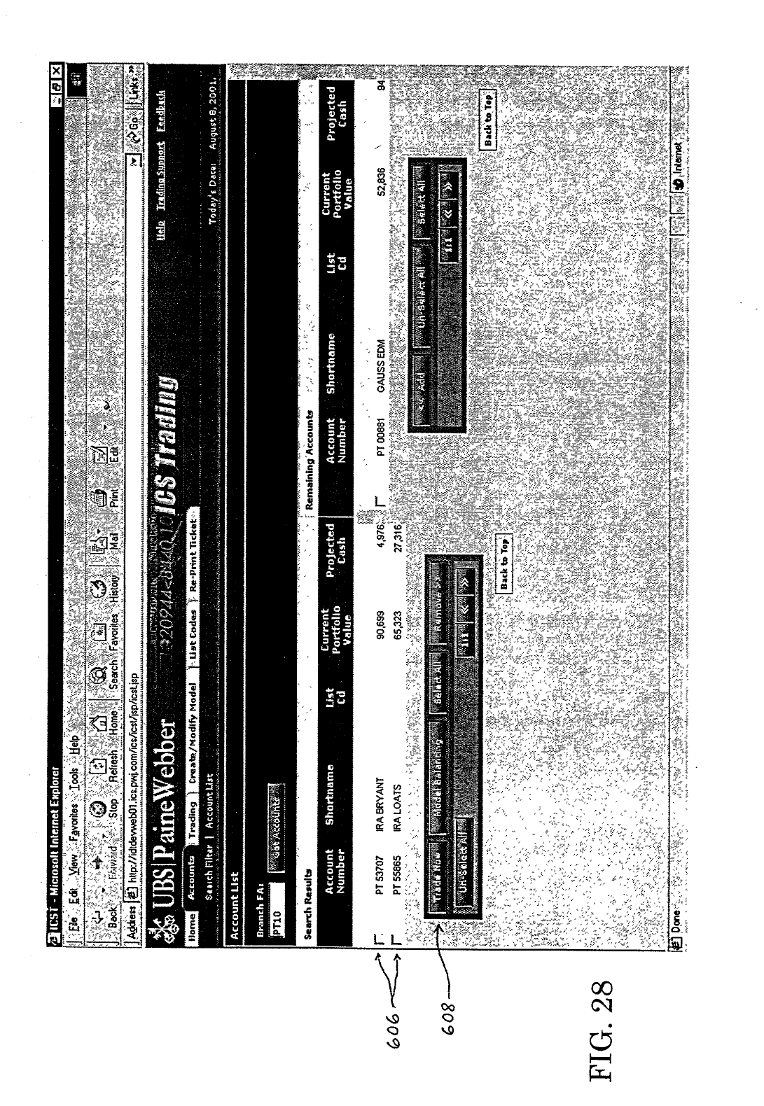

FIG. 26 shows the welcome screen. FIG. 27 shows a search filter screen or tool 600 which can be used to identify one or more accounts of interest. FIG. 27 is illustrative only, and the search parameters need not be exactly as shown. The search results in a subset (i.e., one or more) accounts being selected, as exemplified in FIG. 28. Menu 604 allows accounts to be added or deleted from this list.

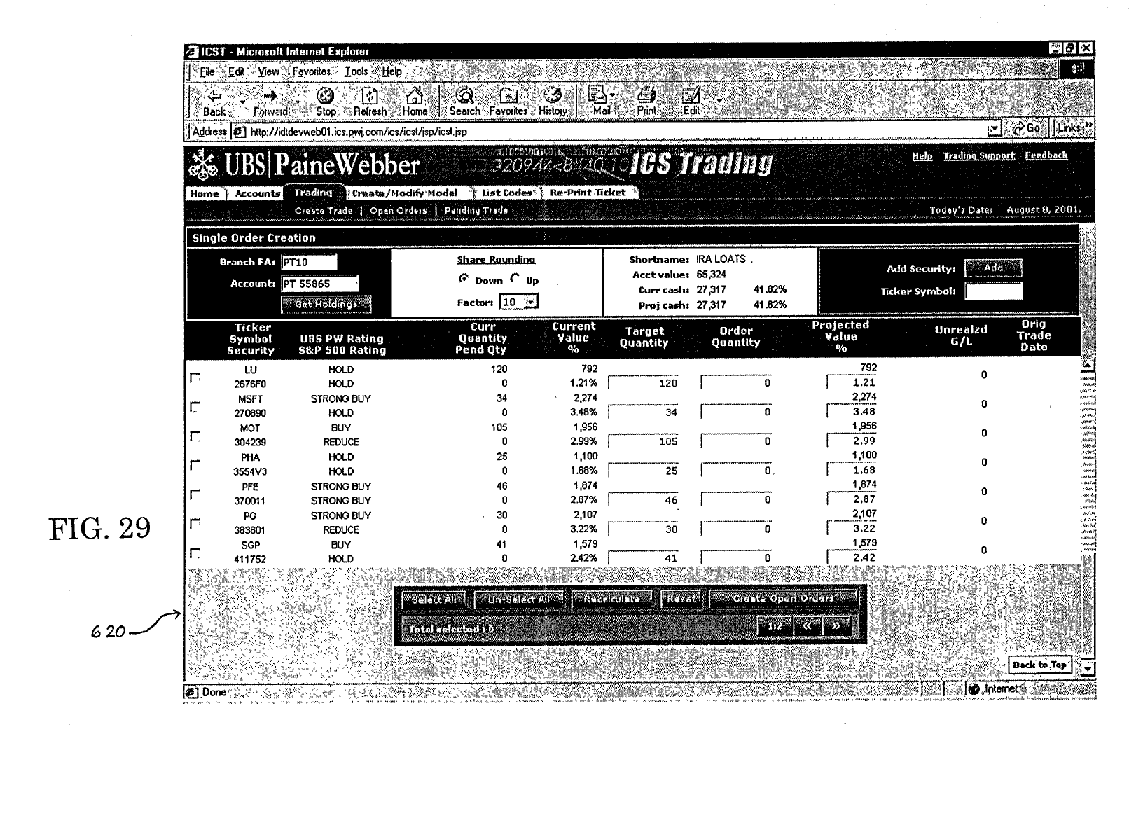

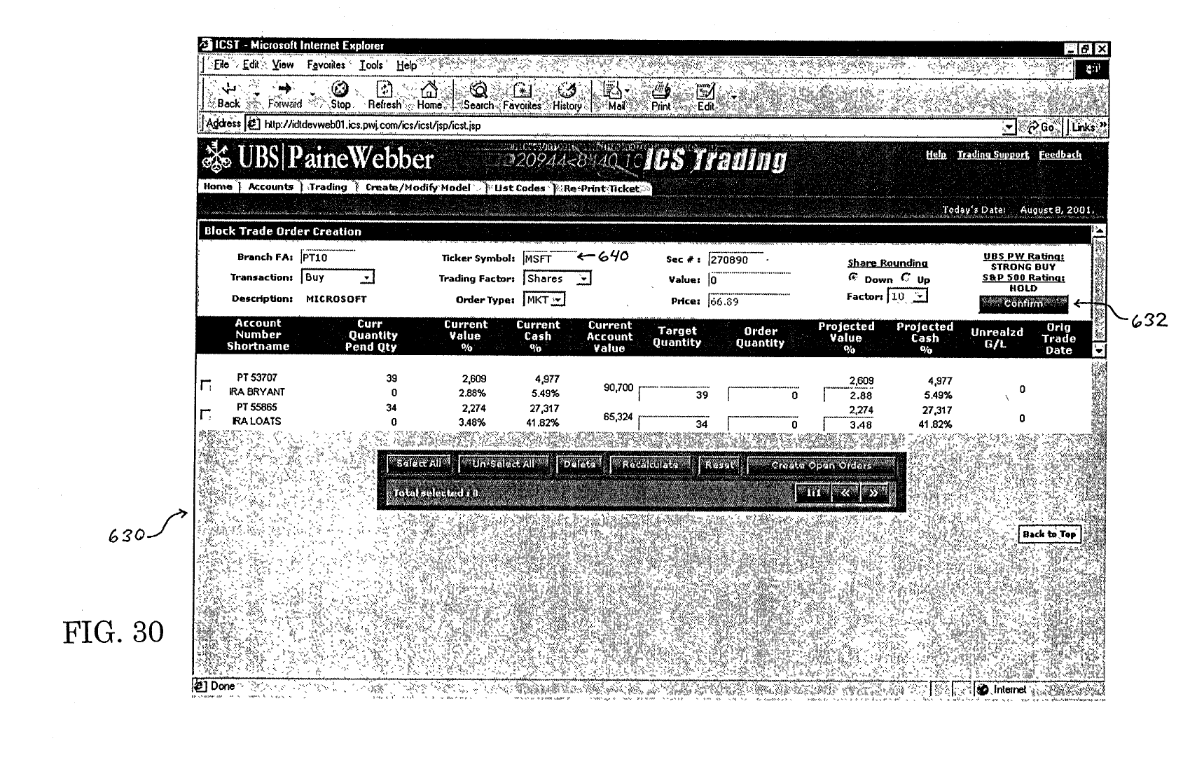

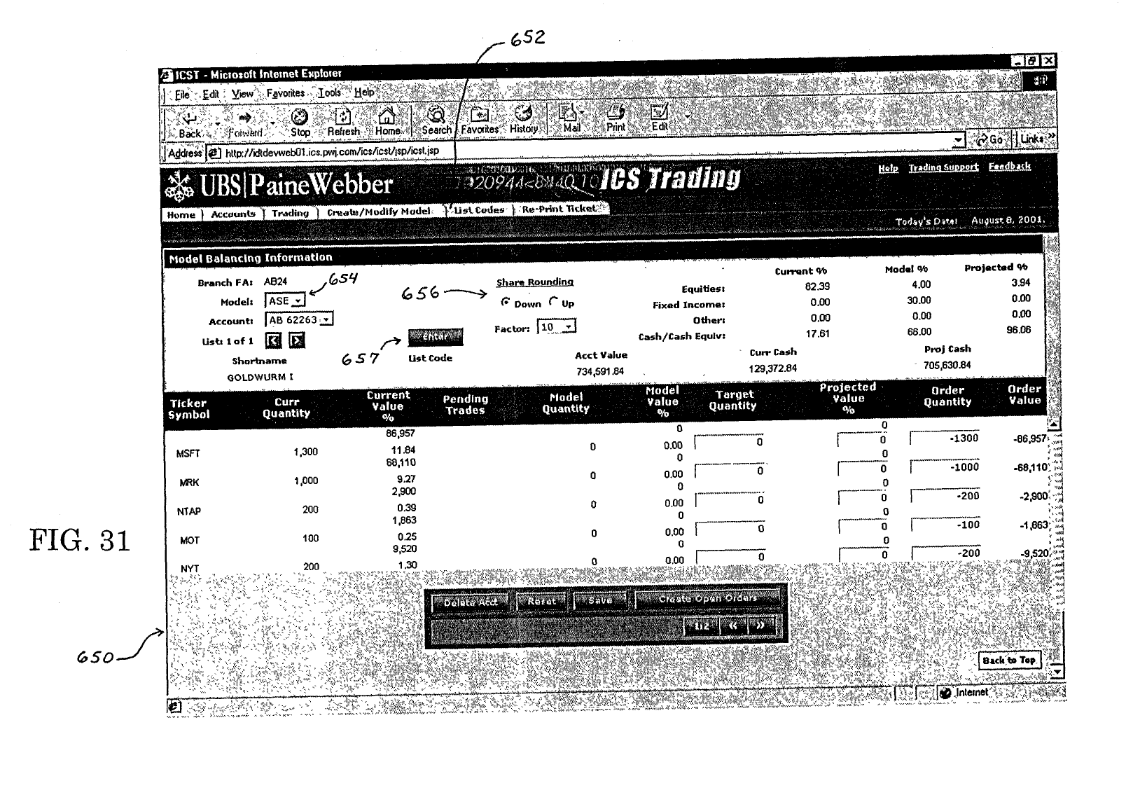

Once the user has a list of accounts, he or she can create trades for the list of accounts. The user must select the desired accounts to create trades by checking the check box 606. If one account is selected and the “trade now” button 608 is clicked, the system will navigate the user to a single order creation screen or tool 620, shown in FIG. 29. If more than one account is selected, and the “trade now” button 608 (FIG. 28) is clicked, the system will navigate the user to a block trade order creation screen or tool 630, shown in FIG. 30. The model balancing button 610 (FIG. 28) navigates the user to an account(s) vs. model balancing screen or tool 650, shown in FIG. 31, which allows the user to balance multiple accounts against a model and automatically create orders for those accounts so as to equalize the accounts with the model.

The single order creation screen or tool 620 (FIG. 29) allows the user to increase, decrease, and liquidate a position or add a new position for a single account. Clicking the “create open orders” button 622 causes the system to create an open order.

The block trade order creation screen or tool 630 (FIG. 30) allows the user to increase, decrease, liquidate, equalize a position or add a new position and create a block trade order for the list of accounts selected on the accounts list screen (FIG. 28). The user enters the following trade information (FIG. 30): transaction, ticker symbol, trading factor, value, order type and price, as well as a share-rounding factor. When the user clicks on the confirm button 632 the portfolio information for each security of each account is displayed.

To increase a position, the user enters the trade information and clicks on the confirm button 632 or he can increase the target quantity 634, order quantity 636 or projected value percent 638. Only one of these can be modified. Clicking on the recalculate button 639 initiates calculations to the other fields as a direct result of the modified field. Similarly, financial positions can be decreased, liquidated and equalized.

To add new a position, the user must type in the new ticker symbol in a ticker symbol box 640 as well as the other trade information and click on the confirm button 642. After the screen is populated with the new trade data, the user can increase the target quantity, order quantity or projected value percent. Only one of these fields can be changed. Once the change is made, clicking on the recalculate button 639 results in the other two editable values being re-calculated.

Clicking on the create open orders button 642 causes a block trading order to be created, i.e., one trade for a designated number of shares, portions of which are allocated to each account as specified in the block trade order creation screen 630.

The accounts vs. model balancing screen or tool 650 (FIG. 31) will allow the user to balance a single account, all accounts, or a subset of accounts against a specific financial model. A “list code” of accounts is a group of accounts selected through menu selection 652 on the basis of a predetermined code in account numbers such as the prefix “AB”. The user must select a model from a model drop-down list 654, enter a share-rounding factor 656 and click on an enter button 657. The screen or tool will then display actual positions and their portfolio percentages, model securities and their portfolio percentages, and new target quantity and percentages (based on the order values). By clicking on the create open orders button 658, the tool automatically creates buy and/or sell orders (subject to the share rounding factor) for financial product(s) required to balance the group of accounts against the selected model. Advantageously, the account balancing tool keeps track of all accounts and orders as well as the allocation resulting from the balancing operation. This is particularly useful for householded accounts, in which an individual or family may have a number of separate accounts but wish to have the aggregate portfolio (i.e., across all accounts) follow a pre-selected financial model.

The ICST also includes an open orders screen (not shown) that displays outstanding trade orders. Orders may be viewed by account or security. A button is provided to execute any open orders. Orders may be executed automatically or manually. Once the method of execution is decided upon, the user selects whether the order is market or limit, and if the latter, the limit price. As soon as this information is entered, the user may press a “submit” button, thereby creating submitted orders or trades.

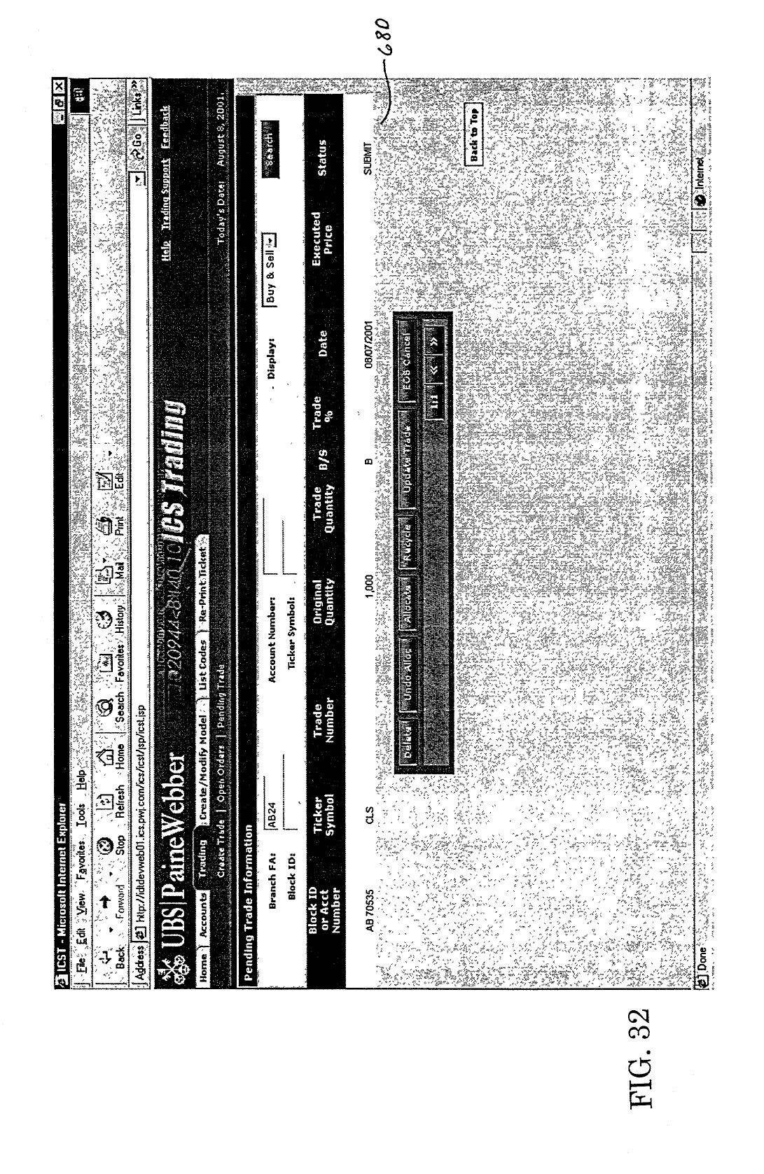

FIG. 32 shows a pending trade status screen that allows the user to view and modify all submitted trades. The user may:

allocate block trades that are either fully or partially executed

delete a manually submitted block trade or individual account

update block trade information

recycle a block trade

cancel an electronic order submission (EOS) trade that has unexecuted quantities

undo a manually submitted allocation

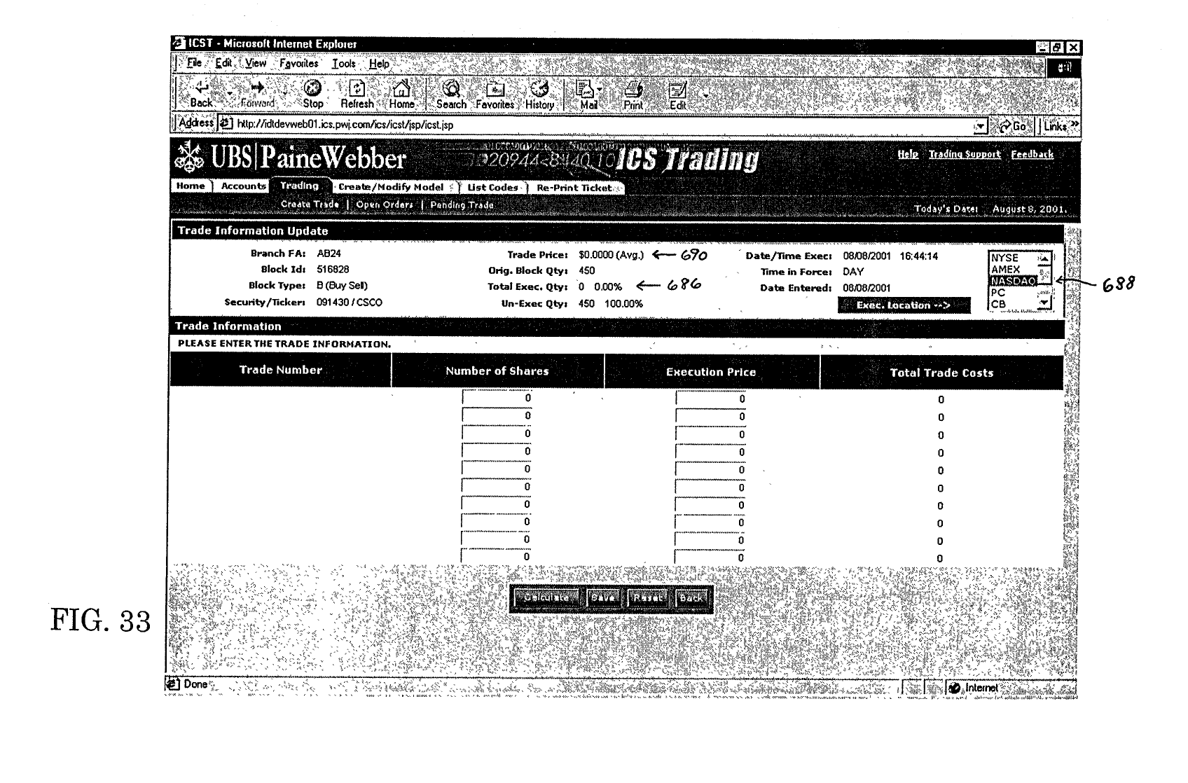

Clicking on an update trade button 684 will bring the user to a trade information update/trade information screen shown in FIG. 33. This screen is primarily used for manually submitted block orders, e.g., larger than 15,000 shares. From this screen the user can enter or update the number of shares executed 686, location 688 and price 690 for a block trade selected from the pending trade staus screen. Clicking on a calculate button 692 and then a save button 694 saves the trade information for subsequent execution.

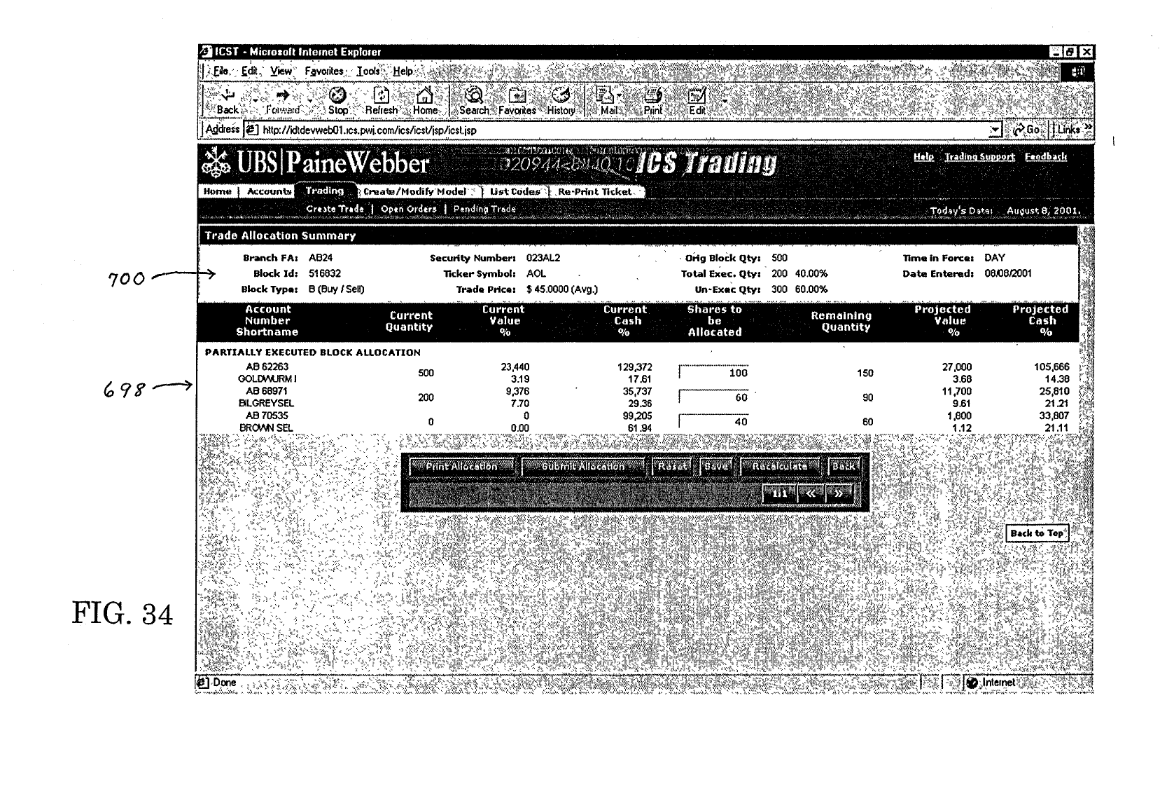

Clicking on an allocate button 696 (on the pending trade screen shown in FIG. 32) causes the system to navigate the user to a trade allocation summary screen, shown in FIG. 34. To allocate a fully executed block trade fully, its status 680 must be partially incomplete (PAR/INC) and the buy/sell percentage 682 must equal one hundred. To allocate a partially executed block trade, its status must be partially incomplete (PAR/INC) and the buy/sell percentage 682 must be less than 100. Manually entered block trade orders have an initial status of “submit” which will change to “partially incomplete” when the parameters of the block trade order are entered via the trade information update/trade information screen of FIG. 33. All orders submitted are blocked together at the time of submission.

The trade allocation summary screen (FIG. 34) allows the user to view, modify, print and submit allocations of block trades. The user must allocate block trades that are submitted manually, and can allocate block trades that are EOS partially executed. If the user makes any changes, he or she must save the changes prior to submitting the allocation by clicking a save button 702. If the user makes no changes, he or she still must click on the save button 702 prior to submitting the allocation for fully executed block trades. To submit the allocation, the user clicks on a submit allocation button 704.

The trade allocation summary screen will also allow the user to view, modify, print and assign individual allocations of manually submitted or partially executed block trades. After selecting the block from the pending trade status screen (FIG. 32) where the buy/sell percentage is less than one hundred and clicking on the update trade button 684, the system navigates the user to the trade information update/trade information screen (FIG. 33) to enter the number of share executed, price and location. When this is completed, the user is navigated back to the pending trade screen (FIG. 32). Clicking on the allocate button 696 will cause a partial allocation method form 698 (FIG. 34) to appear, where the user will be asked how to allocate the partially executed block. The user will have the option to allocate shares either pro-rata or randomly. If “pro-rata” is selected, the shares are allocated on a pro-rata basis. If “random” is selected, the shares are allocated on random basis. Once the user makes a choice on which allocation basis to use, clicking on an “OK” button returns the user to the trade allocation summary 700. To submit the allocation, the user must click on the save button 702 before clicking on the submit allocation button 704. If modifications are made to the shares to be allocated field 706, the recalculate button must also be clicked.

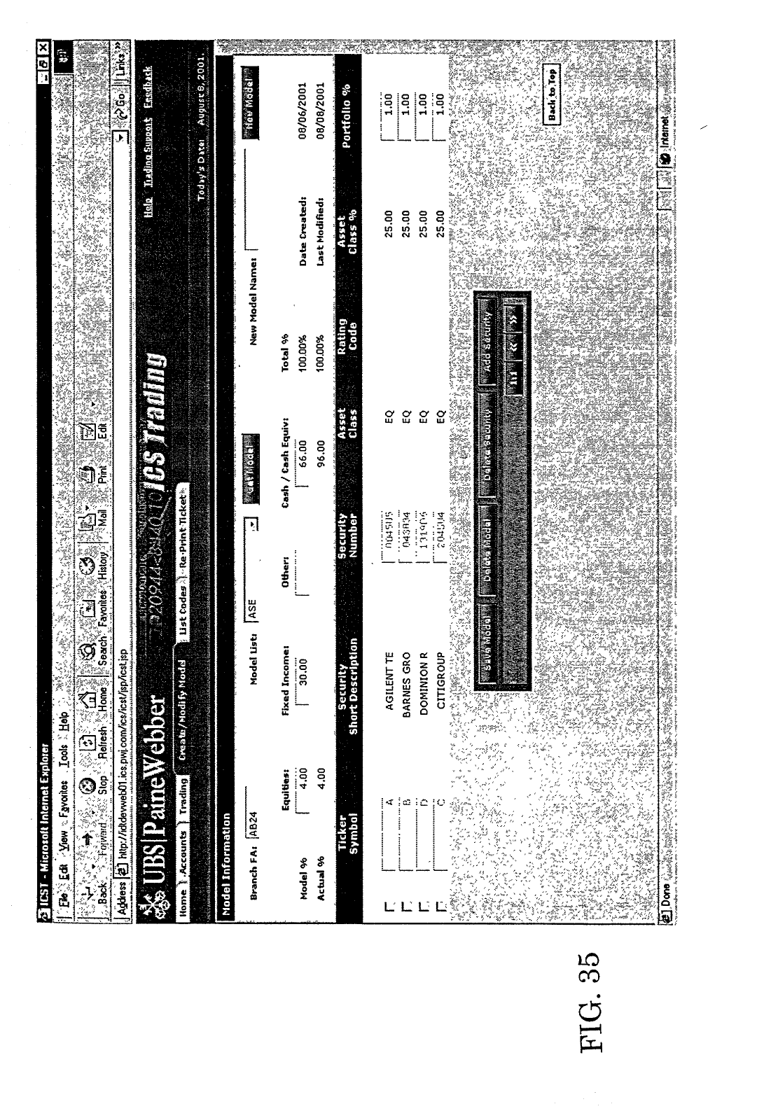

FIG. 35 shows a create/modify model screen or tool that allows the user to create a new model (simple or complex) and its criteria (asset class percentages or securities). It will also allow the user to modify an existing model and view a list of models.

A simple model is based on percentages of equities, fixed income, other and cash/cash equivalent. A complex model is based on percentages (equities, fixed income, other and cash/cash equivalent of the simple model plus desired securities.

The user will have the ability to add or delete securities from a model portfolio. There are two scenarios to add securities:

First, by clicking on the add security button 708, securities can be added by either entering a security number or ticker symbol and portfolio percentage. After adding all the desired securities, the user clicks on the save model button to save the securities information. Models can only be saved when the total portfolio percent of all the securities equals the equity model percentage (e.g., if Equity is set to 60%, then the percentages of all the equity type securities must equal 60%).

Second, a complex model can be modified three ways: it can be modified by deleting and adding securities, deleting securities without adding new ones, or adding securities without deleting existing ones. To delete a security, the user must check the check box of the desired security and click on the delete security button 710. Once a security is deleted, the user must change the portfolio percentages of the existing securities or add new securities before saving the model. The model equity percentage is automatically calculated base on the portfolio percentages of the securities in the model.

To balance accounts against a model the user just created or modified, he or she must either navigate to the account list screen and select an account, all accounts or a subset of accounts or navigate to the search filter screen to search, obtain an account, all accounts or a subset of all accounts from the accounts list screen and click on the model balancing button, (FIG. 28).

C. Client Info

As shown in FIG. 36, the client information task (command tab 402) provides links to the following objects: view 660, branch reports 662, and portfolio management reports 664. The view object 660 enables users to produce client account statements, trade confirmations, 1099 forms and 1042S forms, as indicated in FIG. 32.

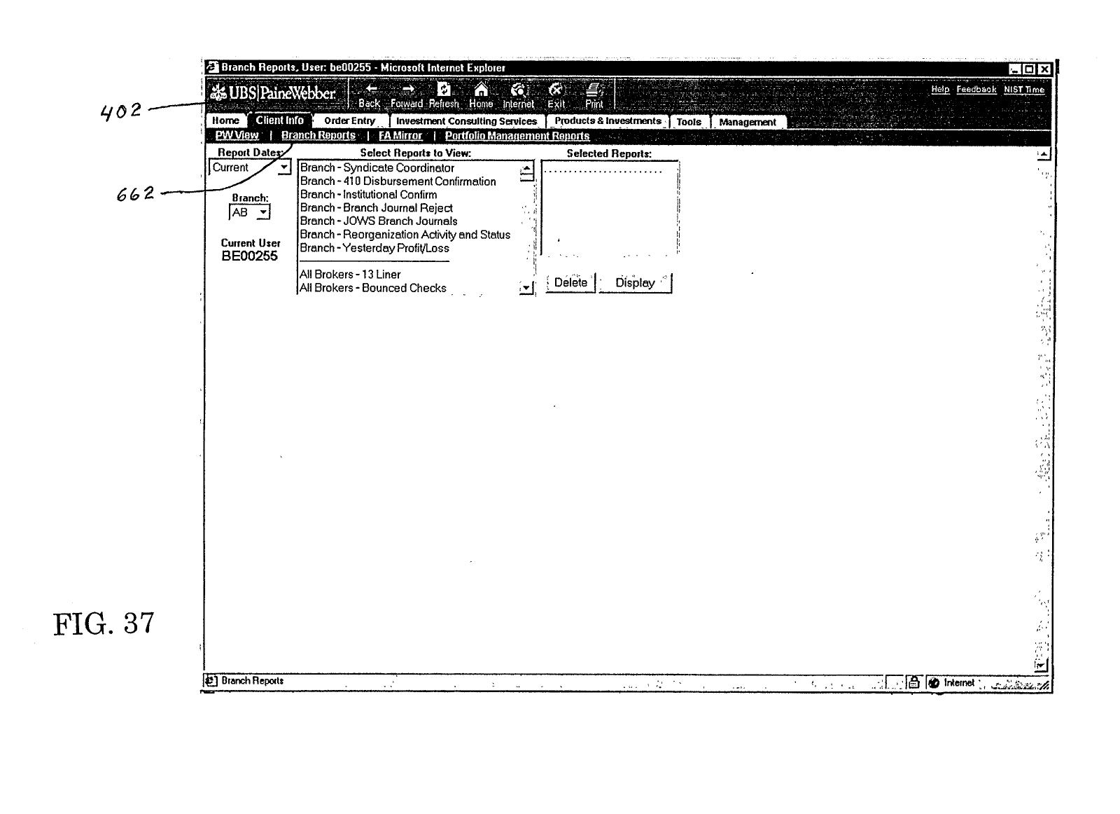

FIG. 37 shows the branch reports object 662, which provides various internal branch reports.

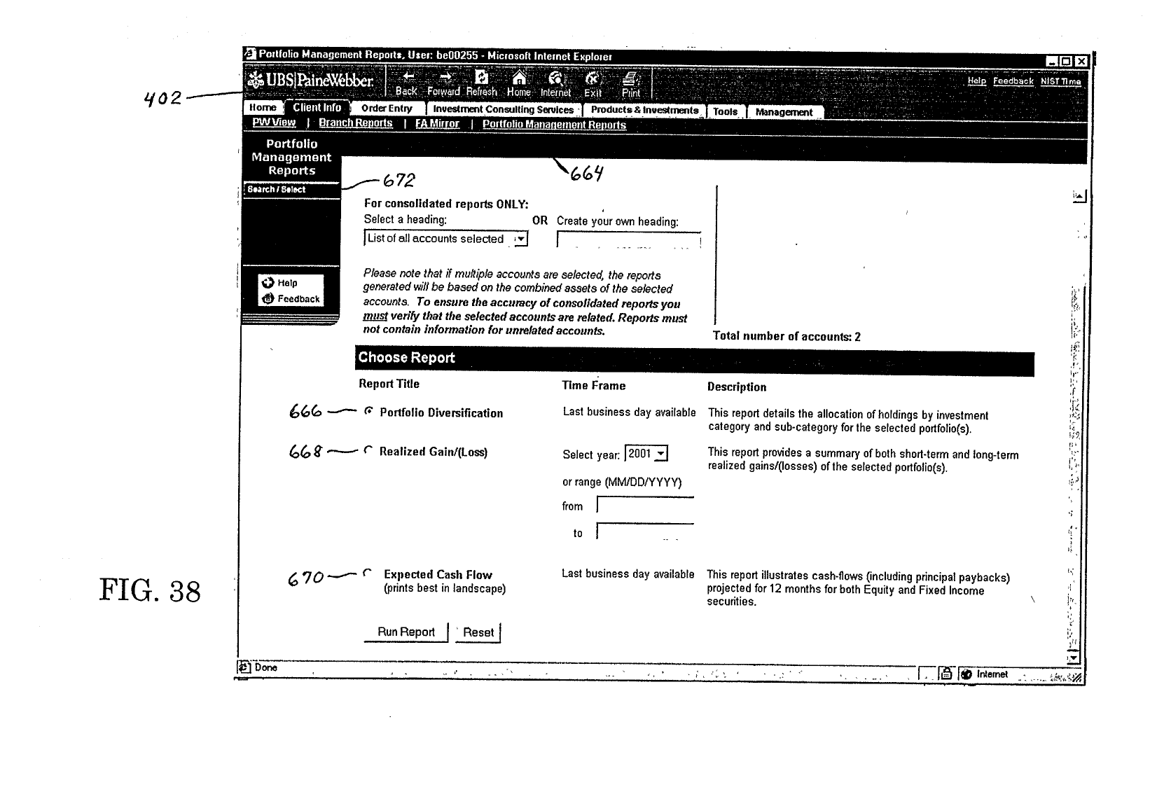

FIG. 38 shows the portfolio management reports object 664. The available reports include a portfolio diversification report 666, which details asset allocation by investment category for single or householded accounts. A realized gain/loss report 668 is also available, as is an expected cash flow report 670. All reports can be run either for one account or for combined multiple accounts.

The cash flow report details expected cash flows, including principle pay-backs, from portfolio holdings (including both equity and fixed income) for 12 monthly periods. This feature includes consolidated reporting, i.e., the ability to generate a cash flow from a plurality of combined accounts, which are selected from the account search menu selection 672. The report can be generated daily or for a user-selected time range.

Referring back to the portfolio diversification report 666, this report is separated by asset class, as for example,

cash (comprising commercial paper, money market funds and treasury bills);

equities (comprising ADR'S, call options, convertible bonds, stock equities, master limited partnerships, and other equity investments, put options and warrants);

fixed income (comprising asset backed securities, certificates of deposit, collateralized mortgage obligations, corporate, federal, municipal and foreign notes and bonds, mortgage pass-through securities, and preferred securities;

other (comprising accident and health insurance payouts, annuities, disability insurance, life insurance, managed futures funds, precious metals, private investments; and

mutual funds (comprising closed and open-ended mutual funds).

A bar chart may also be presented, if desired.

The foregoing embodiment has been described with a certain particularity for the purpose of description. Those skilled in the art will appreciate that numerous modifications and changes may be made to the embodiments described herein without departing from the scope or sprint of the invention.

What is claimed is:

1. A browser interface for providing financial services, comprising:
a browser toolbar;
a task menu providing a plurality user-selected tasks, each task being associated with a group of financial applications;
an object menu associated with a user-selected task, the object menu providing the user with a user-selectable link for initiating each financial application associated with the user-selected task;
an action menu for presenting one or more actions specific to a user-selected financial application; and
at least one view window for presenting information from at least one of the financial applications.

2. The browser interface according to claim 1, wherein each task selection is associated with an object menu that is viewable when the task is selected by the user.

3. The browser interface according to claim 2, wherein the task menu presents one or more of the following task selections:
a default task;
client information;
investor consulting service;
products and investments;
tools; and
management.

4. The browser interface according to claim 3, wherein the default task is associated with one more of the following object menu selections:
research;
applications;
market data;
client inquiring;
infonet; and
dynamic market data.

5. The browser interface according to claim 4, wherein the applications object menu selection is associated with an action menu that provides application selections from the group comprising a client information application; a management application; an operations application; an opportunities application; an investment products application; and a support application.

6. The browser interface according to claim 3, wherein the investor consulting services task is associated with one more of the following object menu selections:
online portfolio review;
financial planning; and
trading.

7. A method of preparing and tracking client presentations, comprising:
uploading to a database a presentation file having a plurality of slides;
splitting the presentation file into individual slides that are separately stored in the database;
providing a user interface for enabling a user to select any of the individual slides for a new client presentation; and
storing in the database the identity of the client for the new client presentation and data indicating the individual slides which compose the new client presentation.

8. The method according to claim 7, wherein the indicating data are references to the individual slides.

9. A method of preparing and tracking client presentations, comprising:
uploading to a database a presentation file having a plurality of slides;
splitting the presentation file into individual slides which are separately stored in the database;
providing a user interface for enabling a user to select any of the individual slides for a new client presentation; and
distributing the new client presentation electronically to one or more individuals.

10. The method according to claim 9, including storing in the database the identity of the client for the new client presentation and data indicating the individual slides which compose the new client presentation.

11. The method according to claim 10, wherein the indicating data are references to the individual slides.

12. The method according to claim 11, wherein the user interface comprises:
a first window panel for enabling a user to select one of the presentation files;
a second window panel for displaying the individual slides associated with the selected presentation file and for enabling the user to select individual slides; and
a third window panel for displaying user-selected individual slides.

13. The method according to claim 12, wherein the first window panel displays a directory structure wherein said presentation files are stored.

14. The method according to claim 13, wherein the third window panel is programmed to enable the user to select the order of the selected individual slides.

15. The method according to claim 14, wherein the presentation files are Microsoft PowerPoint™ files.

16. A system for preparing and tracking client presentations, comprising:
a computer having an associated database;
means for uploading a presentation file having a plurality of slides to the computer;
programming executing on the computer for splitting the presentation file into individual slides and separately storing the individual slides in the database, and for providing a user interface for enabling a user to select any of the individual slides for a new client presentation; and
means for distributing the new client presentation electronically to one or more individuals.

17. The system according to claim 16, wherein the computer is programmed to store in the database the identity of the client for the new client presentation and data indicating the individual slides which compose the new client presentation.

18. The system according to claim 17, wherein the indicating data are references to the individual slides.

19. The system according to claim 18, wherein the user interface comprises:
a first window panel for enabling a user to select one of the presentation files;
a second window panel for displaying the individual slides associated with the selected presentation file and for enabling the user to select individual slides; and
a third window panel for displaying user-selected individual slides.

20. The system according to claim 19, wherein the first window panel displays a directory structure wherein said presentation files are stored.

21. The system according to claim 20, wherein the third window panel is programmed to enable the user to select the order of the selected individual slides.

22. The system according to claim 21, wherein the presentation files are Microsoft PowerPoint™ files.

23. A method of balancing a financial portfolio, comprising:
selecting multiple financial accounts from a database of client financial accounts;
selecting a financial model;
comparing holdings in the selected multiple financial accounts, in aggregate, against the financial model; and
automatically initiating one or more buy and/or sell orders, as required, in order to substantially equalize the selected multiple financial accounts, in aggregate, with the financial model.

24. The method according to claim 23, wherein the selected accounts are balanced with the financial model to within a rounding factor.

25. The method according to claim 23, wherein initiating but and/or sell orders includes initiating one or more block trading orders.

26. The method according to claim 25, including manually updating block trading orders.

27. The method according to claim 25, including executing at least a portion of a block trading order, the unexecuted portion remaining an open order within a trade execution system.

28. The method according to claim 27, including a user specifying the execution price and market location of a block trading order.

29. The method according to claim 23, wherein the model comprises a specified percentage of asset classes, including equities, fixed income products, cash or equivalents thereof, and other types of financial products.

30. The method according to claim 29, wherein the model further includes specific equities and the percentage of the equities asset class.

31. A system for balancing a financial portfolio, comprising:
a server computer system hosting a database of client financial accounts, said server system and database being accessible over a communications network by one or more client computers;
said server system being programmed to enable a user, via the client computers, to select multiple financial accounts from the database, select a financial model stored in said database, compare holdings in the selected multiple financial accounts, in aggregate, against the financial model, and automatically initiate one or more buy and/or sell orders, as required, in order to substantially equalize the selected multiple financial accounts, in aggregate, with the financial model.

32. The system according to claim 31, wherein the selected accounts are balanced with the financial model to within a rounding factor.

33. The system according to claim 31, wherein initiating buy and/or sell orders includes initiating one or more block trading orders.

34. The system according to claim 33, including means for manually updating block trading orders.

35. The system according to claim 33, including means for executing at least a portion of a block trading order, the unexecuted portion remaining an open order within a trade execution system.

36. The system according to claim 35, including means for enabling a user to specify the execution price and market location of a block trading order.

37. The system according to claim 31, wherein the model comprises a specified percentage of asset classes, including equities, fixed income products, cash or equivalents thereof, and other types of financial products.

38. The system according to claim 37, wherein the model further includes specific equities and the percentage of the equities asset class.

39. A method of analyzing a financial portfolio comprising:
selecting a plurality of financial accounts from a database of financial accounts;
selecting a comparative index evaluator against which to evaluate the selected plurality of accounts; and
visually comparing the asset allocation of the selected plurality of accounts against the asset allocation of the comparative index evaluator.

40. The method according to claim 39, wherein the visual comparison includes displaying on a display device a first graphical representation of the asset allocation of the selected accounts and a second graphical representation of the asset allocation of the comparative index evaluator.

41. The method according to claim 39, wherein the visual comparison includes displaying on a display device, a first tabulating of the asset allocation of the selected accounts and a second tabulation of the asset allocation of the comparative index evaluator.
